(19) United States
(12) Patent Application Publication
(10) Pub. No.: US 2023/0373093 A1
(43) Pub. Date: Nov. 23, 2023

(54) PROPOSITION SETTING DEVICE, PROPOSITION SETTING METHOD, AND RECORDING MEDIUM

(71) Applicant: NEC Corporation, Minato-ku, Tokyo (JP)

(72) Inventors: Hiroyuki Oyama, Tokyo (JP); Rin Takano, Tokyo (JP)

(73) Assignee: NEC Corporation, Minato-ku, Tokyo (JP)

(21) Appl. No.: 18/029,278

(22) PCT Filed: Oct. 9, 2020
(86) PCT No.: PCT/JP2020/038312

§ 371 Date: Mar. 29, 2023

(51) Int. Cl. B25J 9/16

(52) U.S. Cl. CPC B25J 9/1671; B25J 9/1666

(57) ABSTRACT

A proposition setting device 1X mainly includes an abstract state setting means 31X and a proposition setting means 32X. The abstract state setting means 31X sets an abstract state which is a state abstracting each object in a workspace based on a measurement result in the workspace where each robot works. The proposition setting means 32X sets a propositional area which represents a proposition concerning each object by an area, based on the abstract state and a relative area information which is information concerning a relative area of each object.

### TECHNICAL FIELD

The present disclosure relates to a technical field of a proposition setting device, a proposition setting method, and a storage medium for performing a process concerning setting of a proposition to be used for an operation plan of a robot.

### BACKGROUND ART

A control method for controlling a robot that is necessary to execute a task is proposed in a case of providing the task on which the robot is caused to work. For example, Patent Document 1 discloses autonomous operation control device that generates an operation control logic and a control logic which satisfy a list of constraint forms into which information of an external environment is converted, and verifies feasibility of the generated operation control logic and the generated control logic.

### PRECEDING TECHNICAL REFERENCES

### Patent Document

Patent Document 1: Japanese Laid-open Patent Publication No. 2007-018490

### SUMMARY

### Problem to be Solved by the Invention

In a case where a proposition concerning a given task is determined and operation plan is performed based on a temporal logic, the problem is how to define the proposition. For example, in a case of expressing an operation forbidden area of a robot, it is necessary to set up a proposition considering an extent (size) of the area. On the other hand, there is a portion unable to be measured by a measurement position or the like in measuring with the sensor, there is a case where it is difficult to appropriately determine such the area.

It is one object of the present disclosure to provide a proposition setting device, a proposition setting method, and a recording medium which are capable of suitably executing settings related to the proposition necessary for the operation plan of the robot.

### Means for Solving the Problem

According to an example aspect of the present disclosure, there is provided a proposition setting device including:
an abstract state setting means configured to set an abstract state which is a state abstracting each object in a workspace based on a measurement result in the workspace where each robot works; and
a proposition setting means configured to set a propositional area which represents a proposition concerning each object by an area, based on the abstract state and relative area information which is information concerning a relative area of each object.

According to another example aspect of the present disclosure, there is provided proposition setting method performed by a computer, including:
setting an abstract state which is a state abstracting each object in a workspace based on a measurement result in the workspace where each robot works; and
setting a propositional area which represents a proposition concerning each object by an area, based on the abstract state and relative area information which is information concerning a relative area of each object.

According to still another example aspect of the present disclosure, there is provided a recording medium storing a program, the program causing a computer to perform a process including:
setting an abstract state which is a state abstracting each object in a workspace based on a measurement result in the workspace where each robot works; and
setting a propositional area which represents a proposition concerning each object by an area, based on the abstract state and relative area information which is information concerning a relative area of each object.

### Effect of the Invention

According to the present disclosure, it is possible to suitably execute settings related to a proposition necessary for an operation plan of a robot.

### BRIEF DESCRIPTION OF THE DRAWINGS

FIG. 1 illustrates a configuration of a robot control system in a first example embodiment.

FIG. 2 illustrates a hardware configuration of a robot controller.

FIG. 3 illustrates a data structure of application information.

FIG. 4 illustrates a functional block of the robot controller.

FIG. 5 illustrates a bird's-eye view of a workplace in a case of using a pick-and-place as an objective task.

FIG. 6 illustrates a bird's-eye view of the workplace of a robot in a case where the robot is a mobile body.

FIG. 7 illustrates an example of a functional block representing a functional configuration of a proposition setting unit.

FIG. 8A illustrates a first setting example of an integration forbidden propositional area. FIG. 8B illustrates a second setting example of the integration forbidden propositional area. FIG. 8C illustrates a third setting example of the integration forbidden propositional area.

FIG. 9 illustrates a bird's-eye view of the workplace in which divided operable areas are specified.

FIG. 10A illustrates a bird's-eye view of the workplace of the robot which clearly shows a forbidden area corresponding to a forbidden propositional area in a case where a space is discretized. FIG. 10B illustrates a bird's-eye view of the workplace of the robot in which a forbidden area larger than that in FIG. 10A.

FIG. 11 illustrates an example of a flowchart representing an overview of a robot control process which is executed by the robot controller in the first example embodiment.

FIG. 12 illustrates an example of a flowchart representing details of a proposition setting process of step S21 in FIG. 11.

FIG. 13 illustrates a schematic configuration diagram of a control device in a second example embodiment.

FIG. 14 is an example of a flowchart executed by the control device in the second example embodiment.

### EXAMPLE EMBODIMENTS

In the following, example embodiments will be described with reference to the accompanying drawings.

### First Example Embodiment

(1) System Configuration

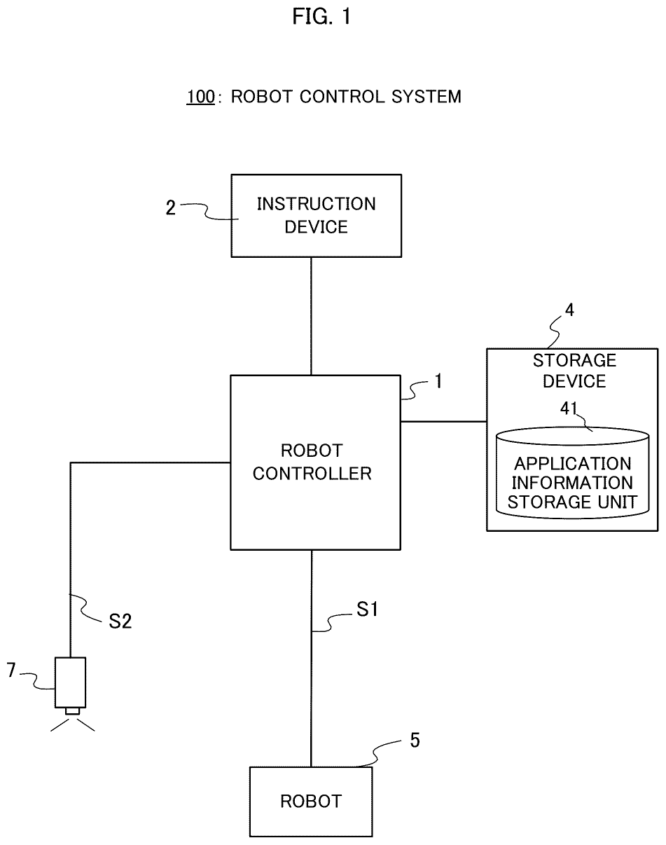

FIG. 1 illustrates a configuration of a robot control system 100 according to a first example embodiment. The robot control system 100 mainly includes a robot controller 1, an instruction device 2, a storage device 4, a robot 5, and a measurement device 7.

In a case where a task to be executed by the robot 5 (also referred to as an “objective task”) is specified, the robot controller 1 converts the objective task into a sequence for each time step of a simple task which the robot 5 can accept, and controls the robot 5 based on the generated sequence.

In addition, the robot controller 1 performs data communications with the instruction device 2, the storage device 4, the robot 5, and the measurement device 7 through a communication network or direct communications by a wireless or wired channel. For instance, the robot controller 1 receives an input signal related to a designation of the objective task, generation, update of application information, or the like from the instruction device 2. Moreover, with respect to the instruction device 2, the robot controller 1 executes a predetermined display or a sound output to the instruction device 2 by transmitting a predetermined output control signal. Furthermore, the robot controller 1 transmits a control signal “S1” related to the control of the robot 5 to the robot 5. Also, the robot controller 1 receives a measurement signal “S2” from the measurement device 7.

The instruction device 2 is a device for receiving an instruction to the robot 5 by an operator. The instruction device 2 performs a predetermined display or sound output based on the output control signal supplied from the robot controller 1, or supplies the input signal generated based on an input of the operator to the robot controller 1. The instruction device 2 may be a tablet terminal including an input section and a display section, or may be a stationary personal computer.

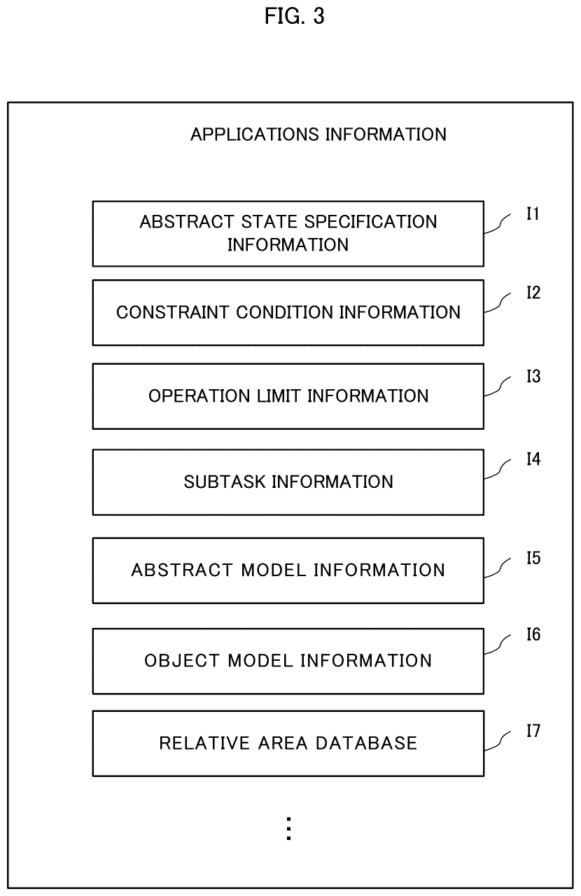

The storage device 4 includes an application information storage unit 41. The application information storage unit 41 stores application information necessary for generating an operation sequence which is a sequence of operations to be executed by the robot 5, from the objective task. Details of the application information will be described later with reference to FIG. 3. The storage device 4 may be an external storage device such as a hard disk connected or built into the robot controller 1, or may be a storage medium such as a flash memory. The storage device 4 may be a server device which performs data communications with the robot controller 1 via the communication network. In this case, the storage device 4 may be formed by a plurality of server devices.

The robot 5 performs a work related to the objective task based on the control signal S1 supplied from the robot controller 1. The robot 5 corresponds to, for instance, a robot that operates in various factories such as an assembly factory and a food factory, or a logistics site. The robot 5 may be a vertical articulated robot, a horizontal articulated robot, or any other type of robot. The robot 5 may supply a state signal indicating a state of the robot 5 to the robot controller 1. The state signal may be an output signal from a sensor (internal sensor) for detecting a state (such as a position, an angle, or the like) of the entire robot 5 or of specific portions such as joints of the robot 5, or may be a signal which indicates a progress of the operation sequence of the robot 5 which is represented by the control signal S1.

The measurement device 7 is one or more sensors (external sensors) formed by a camera, a range sensor, a sonar, or a combination thereof to detect a state in a workspace in which the objective task is performed. The measurement device 7 may include sensors provided in the robot 5 and may include sensors provided in the workspace. In the former case, the measurement device 7 includes an external sensor such as a camera provided in the robot 5, and the measurement range is changed in accordance with the operation of the robot 5. In other examples, the measurement device 7 may include a self-propelled sensor or a flying sensor (including a drone) which moves in the workspace of the robot 5. Moreover, the measurement device 7 may also include a sensor which detects a sound or a tactile sensation of each object in the workspace. Accordingly, the measurement device 7 may include a variety of sensors that detect conditions in the workspace, and may include sensors located anywhere.

Note that the configuration of the robot control system 100 illustrated in FIG. 1 is an example, and various changes may be made to the configuration. For instance, a plurality of the robots 5 may exist, and the robot 5 may be equipped with a plurality of control targets which operate independently such as robot arms. Even in these cases, the robot controller 1 transmits the control signal S1 representing a sequence which defines the operation for each robot 5 or for each control target to the robot 5 to be controlled based on the objective task. Furthermore, the robot 5 may be one that performs a cooperative work with other robots, the operator, or machine tools which operate in the workspace. Moreover, the measurement device 7 may be a part of the robot 5. The instruction device 2 may be formed as the same device as the robot controller 1. In addition, the robot controller 1 may be formed by a plurality of devices. In this case, the plurality of devices forming the robot controller 1 exchanges information necessary to execute a process assigned in advance among these devices. Moreover, the robot controller 1 and the robot 5 may be integrally formed.

(2) Hardware Configuration

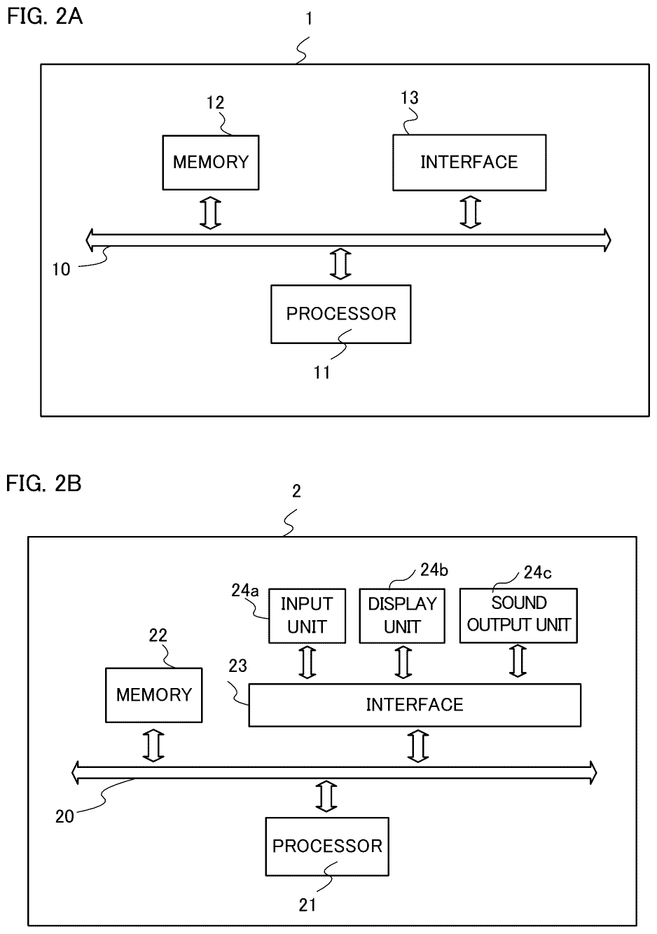

FIG. 2A illustrates a hardware configuration of the robot controller 1. The robot controller 1 includes a processor 11, a memory 12, and an interface 13 as hardware. The processor 11, the memory 12, and the interface 13 are connected via a data bus 10.

The processor 11 functions as a controller (arithmetic unit) for performing an overall control of the robot controller 1 by executing programs stored in the memory 12. The processor 11 is, for instance, a CPU (Central Processing Unit), a GPU (Graphics Processing Unit), a TPU (Tensor Processing Unit) or the like. The processor 11 may be formed by a plurality of processors. The processor 11 is an example of a computer.

The memory 12 includes various volatile and non-transitory memories such as a RAM (Random Access Memory), a ROM (Read Only Memory), a flash memory, and the like. In addition, programs executed by the robot controller 1 are stored in the memory 12. A part of information stored in the memory 12 may be stored by one or a plurality of external storage devices capable of communicating with the robot controller 1, or may be stored in a recording medium detachable from the robot controller 1.

The interface 13 is an interface for electrically connecting the robot controller 1 and other devices. These interfaces may be wireless interfaces such as network adapters or the like for transmitting and receiving data to and from other devices wirelessly, or may be hardware interfaces for connecting the other devices by as cables or the like.

Note that the hardware configuration of the robot controller 1 is not limited to the configuration illustrated in FIG. 2A. For instance, the robot controller 1 may be connected to or built in at least one of a display device, an input device, and the sound output device. The robot controller 1 may be configured to include at least one of the instruction device 2 and the storage device 4.

FIG. 2B illustrates a hardware configuration of the instruction device 2. The instruction device 2 includes, as hardware, a processor 21, a memory 22, an interface 23, an input unit 24a, a display unit 24b, and a sound output unit 24c. The processor 21, the memory 22 and the interface 23 are connected via a data bus 20. Moreover, the input unit 24a, the display unit 24b, the sound output unit 24c, are connected to the interface 23.

The processor 21 executes a predetermined process by executing a program stored in the memory 22. The processor 21 is a processor such as a CPU, a GPU, or the like. The processor 21 receives a signal generated by the input unit 24a via the interface 23, generates the input signal, and transmits the input signal to the robot controller 1 via the interface 23. Moreover, the processor 21 controls at least one of the display unit 24b and the sound output unit 24c via the interface 23 based on the output control signal received from the robot controller 1.

The memory 22 is formed by various volatile memories and various non-transitory memories such as a RAM, a ROM, a flash memory, and the like. Moreover, programs for executing processes executed by the instruction device 2 are stored in the memory 22.

The interface 23 is an interface for electrically connecting the instruction device 2 with other devices. These interfaces may be wireless interfaces such as network adapters or the like for transmitting and receiving data to and from other devices wirelessly, or may be hardware interfaces for connecting the other devices by cables or the like. Moreover, the interface 23 performs interface operations of the input unit 24a, the display unit 24b, and the sound output unit 24c. The input unit 24a is an interface that receives input from a user, and corresponds to, for instance, each of a touch panel, a button, a keyboard, and a voice input device. The display unit 24b corresponds to, for instance, a display, a projector, or the like, and displays screens based on the control of the processor 21. The sound output unit 24c corresponds to, for instance, a speaker, and outputs sounds based on the control of the processor 21.

The hardware configuration of the instruction device 2 is not limited to the configuration depicted in FIG. 2B. For instance, at least one of the input unit 24a, the display unit 24b, and the sound output unit 24c may be formed as a separate device that electrically connects to the instruction device 2. Moreover, the instruction device 2 may also be connected to various devices such as a camera and the like, and may incorporate them.

(3) Application Information

Next, a data structure of the application information stored in the application information storage unit 41 will be described.

FIG. 3 illustrates an example of a data structure of the application information. As illustrated in FIG. 3, the application information includes abstract state specification information I1, constraint condition information I2, operation limit information I3, subtask information I4, abstract model information I5, object model information I6, a relative area database I7, and a relative area database I8.

The abstract state specification information I1 is information that specifies an abstract state necessary to be defined for a generation of the operation sequence. This abstract state abstractly represents a state of each object in the workspace and is defined as a proposition to be used in a target logical formula described below. For instance, the abstract state specification information I1 specifies the abstract state to be defined for each type of the objective task.

The constraint condition information I2 indicates the constraint conditions for executing the objective task. The constraint condition information I2 indicates, for instance, a constraint condition that a contact from the robot (robot arm) to an obstacle is restricted or a constraint condition that a contact between the robots 5 (robot arms) is restricted in a case where the objective task is a pick-and-place, and or other constraint conditions. The constraint condition information I2 may be information in which appropriate constraint conditions are recorded for respective types of the objective tasks.

The operation limit information I3 indicates information concerning an operation limit of the robot 5 to be controlled by the robot controller 1. The operation limit information I3 is, for instance, information defining an upper limit of a speed, an acceleration, or an angular velocity of the robot 5. It is noted that the operation limit information I3 may be information defining an operation limit for each movable portion or each joint of the robot 5.

The subtask information I4 indicates information on subtasks to be components of the operation sequence. The “subtask” is a task in which the objective task is decomposed by a unit which can be accepted by the robot 5, and refers to each subdivided operation of the robot 5. For instance, in a case where the objective task is the pick-and-place, the subtask information I4 defines, as subtasks, a subtask “reaching” that is a movement of the robot arm of the robot 5, and a subtask “grasping” that is the grasping by the robot arm. The subtask information I4 may indicate information of the subtasks that can be used for each type of the objective task.

The abstract model information I5 is information concerning a model abstracting dynamics in the workspace. For instance, the model may be a model that abstracts real dynamics by a hybrid system. In this instance, the abstract model information I5 includes information indicating a switch condition of the dynamics in the hybrid system described above. For instance, in a case of the pick-and-place in which the robot 5 grabs and moves each object to be worked (also referred to as each “target object”) to a predetermined position by the robot 5, the switch condition corresponds to a condition of each target object that cannot be moved unless the target object is gripped by the robot 5. The abstract model information I5 includes, for instance, information concerning the model being abstracted for each type of the objective task.

The object model information I6 is information concerning an object model of each object in the workspace to be recognized from the measurement signal S2 generated by the measurement device 7. Examples of the above-described each object include the robot 5, an obstacle, a tool and any other target object handled by the robot 5, a working body other than the robot 5. The object model information I6 includes, for instance, information necessary for the control device 1 to recognize a type, a position, a posture, a currently executed operation, and the like of each object described above, and three-dimensional shape information such as CAD (Computer Aided Design) data for recognizing a three-dimensional shape of each object. The former information includes parameters of an inference engine which are acquired by learning a training model in a machine learning such as a neural network. For instance, the above-mentioned inference engine is trained in advance to output the type, the position, the posture, and the like of each object to be a subject in the image when an image is inputted to the inference engine. Moreover, in a case where an AR marker for an image recognition is attached to a main object such as the target object, information necessary for recognizing the object by the AR marker may be stored as the object model information I6.

The relative area database I7 is a database of information (also called “relative area information”) representing relative areas of objects (including two-dimensional areas such as a goal point and the like) which may be present in the workspace. The relative area information is an area approximating the object of interest, and may be information representing a two-dimensional area such as a polygon or a circle or information representing a three-dimensional area such as a convex polyhedron or a sphere (ellipsoid). Each relative area represented by the relative area information is an area in a relative coordinate system defined so as not to depend on a position and a posture of the object to be a target, and is set in advance in consideration of an actual size and an actual shape of the object to be the target. The above-described relative coordinate system may be, for instance, a coordinate system in which a center position of the object is set as an origin and a front direction of the object is aligned with a positive direction of a certain coordinate axis. The relative area information may be CAD data or may be mesh data.

The relative area information is provided for each type of the object, and is registered in the relative area database I7 by associating with a corresponding type of the object. In this case, for instance, the relative area information is generated in advance for each variation of a combination of shapes and sizes of objects which may be present in the workspace. In other words, for an object differ in either shape or size, the type of the object is considered to be different, and the relative area information for each type is registered in the relative area database I7. In a preferred example embodiment, the relative area information is registered in the relative area database I7 in association with the identification information of the object recognized by the robot controller 1 based on the measurement signal S2. The relative area information is used to determine an area of a proposition (also called “propositional area”) in which the concept of the area exists.

Note that in addition to the information described above, the application information storage unit 41 may store various information necessary for the robot controller 1 to generate the control signal S1. For instance, the application information storage unit 41 may store information which specifies the workspace of the robot 5. In other examples, the application information storage unit 41 may store information of various parameters used in the integration of the propositional areas or the division of the propositional area.

(4) Process Overview

Next, an outline of the process by the robot controller 1 will be described. Schematically, in a case of setting the proposition concerning each object present in the workplace, the robot controller 1 sets the propositional area based on the relative area information related to the object and the relative area database I7. Moreover, the robot controller 1 performs the integration of the propositional areas being set or the division of the propositional area being set. Accordingly, the robot controller 1 performs the operation plan of the robot 5 based on the temporal logic by suitably considering the size of the object (that is, a spatial extent), and suitably controls the robot 5 so as to complete the objective task.

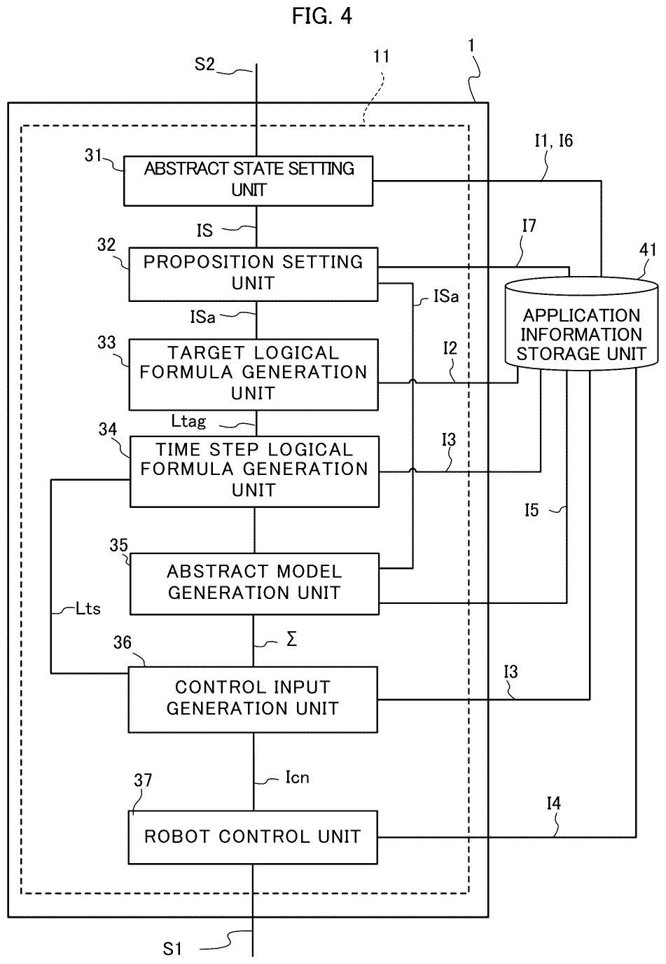

FIG. 4 is an example of a functional block illustrating the outline of the process of the robot controller 1. The processor 11 of the robot controller 1 functionally includes an abstract state setting unit 31, a proposition setting unit 32, a target logical formula generation unit 33, a time step logical formula generation unit 34, an abstract model generation unit 35, a control input generation unit 36, and a robot control unit 37. Note that an example of a data exchange performed between the blocks is illustrated in FIG. 4; however, the data exchange is not limited thereto. The same applies to the drawings of other functional blocks described below.

The abstract state setting unit 31 sets the abstract state in the workspace based on the measurement signal S2 supplied from the measurement device 7, the abstract state specification information I1, and the object model information I6. In this case, when the measurement signal S2 is received, the abstract state setting unit 31 refers to the object model information I6 or the like, and recognizes an attribute such as the type or the like, the position, and the posture, and the like of each object in the workspace which are necessary to be considered at a time of executing the objective task. A recognition result of the state is represented, for instance, as a state vector. The abstract state setting unit 31 defines a proposition for representing each abstract state in a logical formula, which is necessary considered at a time of executing the objective task, based on the recognition result for each object. The abstract state setting unit 31 supplies information indicating the set abstract state (also referred to as “abstract state setting information IS”) to the proposition setting unit 32.

The proposition setting unit 32 refers to the relative area database I7 and sets the propositional area which is an area to be set for the proposition. Moreover, the proposition setting unit 32 redefines the related propositions by integrating adjacent propositional areas which correspond to the operation forbidden areas of the robot 5 and by dividing the propositional area corresponding to the operable area of the robot 5. The proposition setting unit 32 supplies setting information of the abstract state (also referred to as “abstract state re-setting information ISa”) including information related to the redefined propositions and the set propositional area to the abstract model generation unit 35. The abstract state re-setting information ISa corresponds to information in which the abstract state setting information IS is updated based on the process result of the proposition setting unit 32.

Based on the abstract state setting information IS, the target logical formula generation unit 33 converts the specified objective task into a logical formula of a temporal logic (also called a “target logical formula Ltag”) representing a final achievement state. In this case, the target logical formula generation unit 33 refers to the constraint condition information I2 from the application information storage unit 41, and adds the constraint condition to be satisfied in the execution of the target logical formula Ltag. Then, the target logical formula generation unit 33 supplies the generated target logical formula Ltag to the time step logical formula generation unit 34.

The time step logical formula generation unit 34 converts the target logical formula Ltag supplied from the target logical formula generation unit 33 into the logical formula (also referred to as a “time step logical formula Lts”) representing the state at each of time steps. The time step logical formula generation unit 34 supplies the generated time step logical formula Lts to the control input generation unit 36.

Based on the abstract model information I5 and the abstract state re-setting information ISa, the abstract model generation unit 35 generates an abstract model “E” which is a model abstracting the actual dynamics in the workspace. The method for generating an abstract model E will be described later. The abstract model generation unit 35 supplies the generated abstract model E to the control input generation unit 36.

The control input generation unit 36 determines the control input to the robot 5 for each time step to satisfy the time step logical formula Lts supplied from the time step logical formula generation unit 34 and the abstract model E supplied from the abstract model generation unit 35 and to optimize an evaluation function. The control input generating unit 36 supplies information related to the control input (also referred to as “control input information Icn”) to the robot 5 for each time step to the robot controller 37.

The robot control unit 37 generates the control signal S1 representing the sequence of subtasks which is interpretable for the robot 5 based on the control input information Icn supplied from the control input generation unit 36 and the subtask information I4 stored in the application information storage unit 41. Next, the robot control unit 37 supplies the control signal S1 to the robot 5 through the interface 13. Note that the robot 5 may include a function corresponding to the robot control unit 37 in place of the robot controller 1. In this instance, the robot 5 executes an operation for each planned time step based on the control input information Icn supplied from the robot controller 1.

As described above, the target logical formula generation unit 33, the time step logical formula generation unit 34, the abstract model generation unit 35, the control input generation unit 36, and the robot control unit 37 generate the operation sequence of the robot 5 using the temporal logic based on the abstract state (including the state vector, the proposition, and the propositional area) set by the abstract state setting unit 31 and the proposition setting unit 32. The target logical formula generation unit 33, the time step logical formula generation unit 34, the abstract model generation unit 35, the control input generation unit 36, and the robot control unit 37 correspond to an example of an operation sequence generation means.

Here, each of components of the abstract state setting unit 31, the proposition setting unit 32, the target logical formula generation unit 33, the time step logical formula generation unit 34, the abstract model generation unit 35, the control input generation unit 36, and the robot control unit 37 can be realized, for instance, by the processor 11 executing a corresponding program. Moreover, the necessary programs may be recorded on any non-volatile storage medium and installed as necessary to realize each of the components. Note that at least a portion of each of these components may be implemented by any combination of hardware, firmware, and software, or the like, without being limited to being implemented by the software based on the program. At least some of these components may also be implemented using a user programmable integrated circuitry such as, for instance, an FPGA (Field-Programmable Gate Array) or a microcontroller. In this case, the integrated circuit may be used to realize the program formed by each of the above components. At least some of the components may also be comprised of an ASSP (Application Specific Standard Produce), an ASIC (Application Specific Integrated Circuit), or a quantum computer control chip. Thus, each component may be implemented by various hardware. The above is the same in other example embodiments described later. Furthermore, each of these components may be implemented by cooperation of a plurality of computers, for instance, using a cloud computing technology.

(5) Details of Each Process Unit

Next, details of a process performed by each process unit described in FIG. 4 will be described in order.

(5-1) Abstract State Setting Unit

First, the abstract state setting unit 31 refers to the object model information I6 and analyzes the measurement signal S2 by a technique (a technique using an image processing technique, an image recognition technique, a speech recognition technique, an RFID (Radio Frequency Identifier) or the like) which recognizes the environment of the workspace, thereby recognizing the state and the attribute (type or the like) of each object existing in the workspace. As the image recognition technique described above, there are a semantic segmentation based on a deep learning, a model matching, a recognition using an AR marker, and the like. The above recognition result includes information such as the type, the position, and the posture of each object in the workspace. The object in the workspace is, for instance, the robot 5, a target object such as a tool or a part handled by the robot 5, an obstacle and another working body (a person or another object performing a work other than the robot 5), or the like.

Next, the abstract state setting unit 31 sets the abstract state in the workspace based on the recognition result of the object by the measurement signal S2 or the like and the abstract state specification information I1 acquired from the application information storage unit 41. In this case, first, the abstract state setting unit 31 refers to the abstract state specification information I1, and recognizes the abstract state to be set in the workspace. Note that the abstract state to be set in the workspace differs depending on the type of the objective task. Therefore, in a case where the abstract state to be set for each type of the objective task is specified in the abstract state specification information I1, the abstract state setting unit 31 refers to the abstract state specification information I1 corresponding to the specified objective task, and recognizes the abstract state to be set.

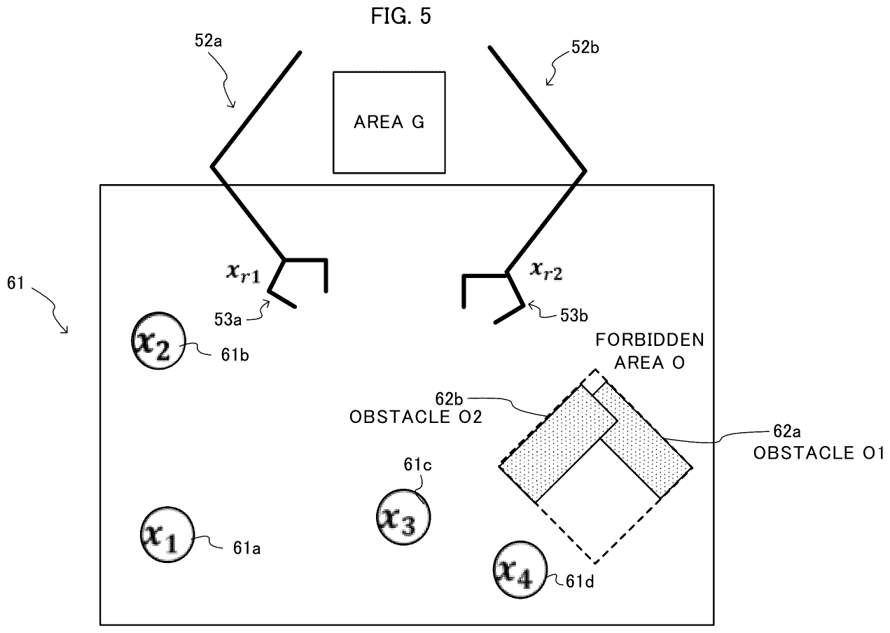

FIG. 5 illustrates a bird's-eye view of the workspace in a case of using the pick-and-place as the objective task. In the workspace illustrated in FIG. 5, there are two robot arms 52a and 52b, four target objects 61 (61a to 61d), obstacles 62a and 62b, and an area G which is the destination of the target objects 61.

In this case, first, the abstract state setting unit 31 recognizes the state of each object in the workspace. In detail, the abstract state setting unit 31 recognizes the state of the target objects 61, the state (here, presence ranges or the like) of the obstacles 62a and 62b, the state of the robot 5, the state of the area G (here, the presence range or the like), and the like.

Here, the abstract state setting unit 31 recognizes position vectors “x₁” to “x₄” of centers of the target objects 61a to 61d as the positions of the target objects 61a to 61d. Moreover, the abstract state setting unit 31 recognizes a position vector “xᵣ₁” of a robot hand 53a for grasping the target object and a position vector “xᵣ₂” of a robot hand 53b respectively as positions of the robot arm 52a and the robot arm 52b. Note that these position vectors x₁ to x₄, xᵣ₁, and xᵣ₂ may be defined as state vectors including various elements concerning the states such as elements related to the postures (angles), elements related to speed, and the like of the corresponding objects.

Similarly, the abstract state setting unit 31 recognizes the presence ranges of the obstacles 62a and 62b, the presence range of the area G, and the like. For instance, the abstract state setting unit 31 recognizes respective center positions of the obstacles 62a and 62b and the area G, or respective position vectors representing the corresponding reference positions. Each position vector is used, for instance, in to set the propositional area using the relative area database I7.

The abstract state setting unit 31 determines the abstract state to be defined in the objective task by referring to the abstract state specification information I1. In this instance, the abstract state setting unit 31 determines the proposition indicating the abstract state based on the recognition result regarding an object existing in the workspace (for instance, the number of objects for each type) and the abstract state specification information I1.

In the example in FIG. 5, the abstract state setting unit 31 adds the identification labels “1” to “4” to the target objects 61a to 61d recognized based on the measurement signal S2 and the like. In addition, the abstract state setting unit 31 defines a proposition “gᵢ” that target objects “i” (i=1 to 4) exist in the area G which is a target point to be finally placed. Moreover, the abstract state setting unit 31 applies an identification labels “O1” and “O2” respectively to the obstacles 62a and 62b, and defines a proposition “o₁ᵢ” that the target object i is interfering with the obstacle O1 and a proposition “o₂ᵢ” that the target object i is interfering with the obstacle O2. Furthermore, the abstract state setting unit 31 defines a proposition “h” that the robot arms 52 interfere with each other. As will be described later, the obstacle O1 and the obstacle O2 are redefined by the proposition setting unit 32 as the forbidden area “O” which is the integrated propositional area.

As described above, the abstract state setting unit 31 recognizes abstract states to be defined by referring to the abstract state designation information I1, and defines propositions (in the above-described example, gᵢ, o₁ᵢ, o₂ᵢ, h, and the like) representing the abstract state in accordance with the number of the target objects 61, the number of the robot arms 52, the number of the obstacles 62, the number of the robots 5, and the like. Next, the abstract state setting unit 31 supplies information representing the set abstract states (including the propositions and the state vectors representing the abstract states) as the abstract state setting information IS to the proposition setting unit 32.

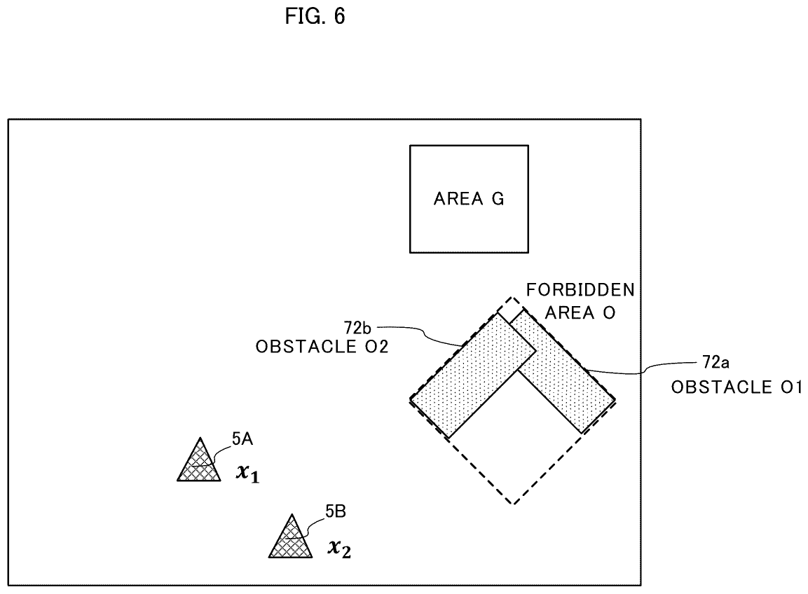

FIG. 6 illustrates a bird's-eye view of the workspace (operation range) of the robot 5 in a case where the robot 5 is a mobile body. In the workspace illustrated in FIG. 6, there are two robots 5A and 5B, obstacles 72a and 72b, and the area G, which is the destination of the robots 5A and 5B.

In this case, first, the abstract state setting unit 31 recognizes the state of each object in the workspace. In detail, the abstract state setting unit 31 recognizes the positions, the postures and the moving speeds of the robots 5A and 5B, the existence regions of the obstacle 72 and the area G, and the like. Next, the abstract state setting unit 31 sets a state vector “x₁” representing the position and the posture (and the moving speed) of the robot 5A, and a state vector “x₂” representing the position, the posture (and the moving speed) of the robot 5B, respectively. Moreover, the abstract state setting unit 31 represents the robots 5A and 5B by robots “i” (i=1 to 2), and defines the propositions “gᵢ” that the robots i exist in the area G which is the target point to be finally placed. In addition, the abstract state setting unit 31 adds identification labels “O1” and “O2” to the obstacles 72a and 72b, defines the proposition “o₁ᵢ” that the robot i is interfering with the obstacle O1 and the proposition “o₂ᵢ” that the robot i is interfering with the obstacle O2. Furthermore, the abstract state setting unit 31 defines the proposition “h” that the robots i interfere with each other. As will be described later, the obstacle O1 and the obstacle O2 are defined by the proposition setting unit 32 as the forbidden area “O” which is the integrated propositional area.

Accordingly, the abstract state setting unit 31 recognizes each abstract state to be defined even in a case where the robot 5 is the mobile body, and can suitably set the propositions representing the abstract states. Next, the abstract state setting unit 31 supplies information indicating the propositions representing the abstract state to the proposition setting unit 32 as the abstract state setting information IS.

Note that the task to be set may be a case in which the robot 5 moves and performs the pick-and-place (that is, the task corresponds to a combination of the examples of FIG. 5 and FIG. 6). Even in this case the abstract state setting unit 31 generates the abstract state setting information IS representing the abstract states and the propositions representing the abstract states which encompass both the examples in FIG. 5 and FIG. 6.

(5-2) Proposition Setting Unit

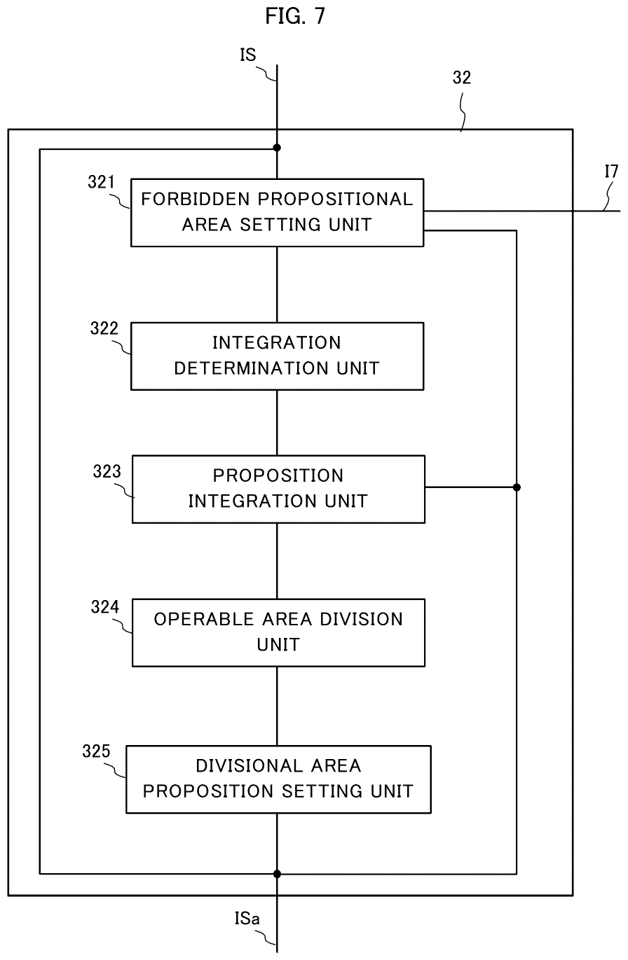

FIG. 7 is an example of a functional block diagram illustrating a functional configuration of the proposition setting unit 32. The proposition setting unit 32 functionally includes a forbidden propositional area setting unit 321, an integration determination unit 322, a proposition integration unit 323, an operable area division unit 324, and a divisional area proposition setting unit 325. In the following, processes executed by the proposition setting unit 32 will be described in order of the setting of the propositional area (also referred to as a “forbidden propositional area”) representing an area in which the operation of the robot 5 is forbidden, the integration of the forbidden propositional area, and the division of an operable area of the robot 5.

(5-2-1) Setting of the Forbidden Propositional Area

The forbidden propositional area setting unit 321 sets the forbidden propositional area representing an area where the operation of the robot 5 is forbidden based on the abstract state setting information IS, the relative area database I7, and the like. In this case, for instance, for each of objects recognized as the obstacles by the abstract state setting unit 31, the forbidden propositional area setting unit 321 extracts relative area information corresponding to these objects from the relative area database I7, and sets respective forbidden propositional areas.

Here, as a specific example, a process for setting the forbidden propositional areas will be described, regarding the propositions o₁ᵢ, and o₂ᵢ defined in the examples in FIG. 5 and FIG. 6. In this case, first, the forbidden propositional area setting unit 321 extracts the relative area information which is associated with the types of the objects corresponding to the obstacle O1 and the obstacle O2 in the relative area database I7. Next, the forbidden propositional area setting unit 321 determines, in the workspace, relative areas indicated in the relative area information extracted from the relative area database I7 based on the positions and the postures of the obstacle O1 and the obstacle O2. After that, the forbidden propositional area setting unit 321 sets the respective relative areas of the obstacle O1 and the obstacle O2 set based on the positions and the postures of the obstacle O1 and the obstacle O2 as the forbidden propositional areas.

Here, the relative areas indicated in the relative area information are virtual areas in which the obstacle O1 and the obstacle O2 are modeled in advance. Therefore, by setting the relative areas in the workspace based on the positions and the postures of the obstacle O1 and the obstacle O2, it is possible for the forbidden propositional area setting unit 321 to set the forbidden propositional areas which are suitably abstracting the existing obstacle O1 and obstacle O2.

(5-2-2) Integration of the Forbidden Propositional Areas

Next, a process which is executed by the integration determination unit 322 and the proposition integration unit 323 will be described, regarding the integration of the forbidden propositional areas.

The integration determination unit 322 determines whether or not the integration of the forbidden propositional areas set by the forbidden propositional area setting unit 321 needs to be integrated. In this case, for instance, the integration determination unit 322 calculates an increase rate (also referred to as an “integration increase rate Pu”) of an area (when the forbidden propositional area is a two-dimensional area) or a volume (when the forbidden propositional area is a three-dimensional area) in a case of the integration for any combination of two or more of the forbidden propositional areas which are set by the forbidden propositional area setting unit 321. Next, when there is a combination of the forbidden propositional areas where the integration increase rate Pu is equal to or less than a predetermined threshold value (also referred to as a “threshold value Puth”), the integration determination unit 322 determines that the combination of the forbidden propositional areas is to be integrated. Here, in detail, the integration increase rate Pu indicates a rate of the ‘area or volume of the area integrating the combination of the forbidden propositional areas of the subjects’ to a ‘sum of the areas or volumes occupied by the forbidden propositional areas of the subjects’. Moreover, for instance, the threshold value Puth is stored in advance in the storage device 4, the memory 12, or the like. Note that the integration increase rate Pu is not limited to a value calculated based on the comparison of the areas or the volumes before and after the integration of the forbidden propositional areas. For instance, the integration increase rate Pu may be calculated based on the comparison of sums of perimeter lengths before and after the integration of the forbidden propositional areas.

For instance, in the example in FIG. 5 or FIG. 6, since the integration increase ratio Pu for the combination of the forbidden propositional areas for the obstacle O1 and the obstacle O2 is equal to or less than the threshold value Puth, the integration determination unit 322 determines that these forbidden propositional areas is to be integrated.

The proposition integration unit 323 newly sets a forbidden propositional area (also referred to as an “integration forbidden propositional area”) integrating the combination of the forbidden propositional areas which are determined by the integration determination unit 322 to be integrated, and redefines the proposition corresponding to the set integration forbidden propositional area. For instance, in the example in FIG. 5 or FIG. 6, the proposition integration unit 323 sets a “forbidden area O” which is an integration forbidden propositional area indicated by a dashed line frame based on the forbidden propositional areas of the obstacle O1 and the obstacle O2 which the integration determination unit 322 determines to be integrated. Furthermore, the proposition integration unit 323 sets the proposition oᵢ that “the target object i is interfering with the forbidden area O” with respect to the forbidden area O in the case of the example in FIG. 5, and sets the proposition oᵢ that “the robot i is interfering with the forbidden area O” in the case of the example in FIG. 6.

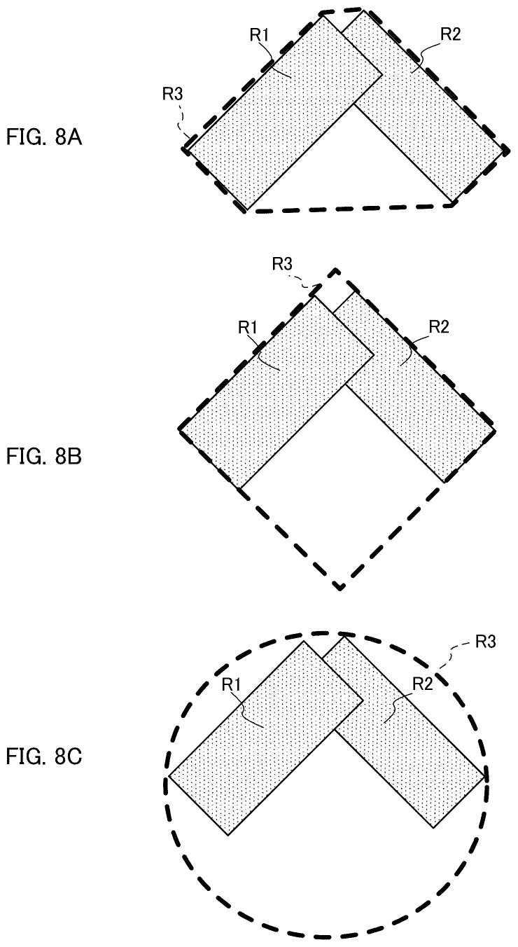

Here, a concrete aspect concerning the integration of the forbidden propositional areas will be described. FIG. 8A illustrates a first setting example of an integration forbidden propositional area R3 for the forbidden propositional areas R1 and R2. FIG. 8B illustrates a second setting example of the integration forbidden propositional area R3 for the forbidden propositional areas R1 and R2, and FIG. 8C illustrates a third setting example of the integration forbidden propositional area R3 for the forbidden propositional areas R1 and R2. For convenience of explanation, for instance, the forbidden propositional areas R1 and R2 are two-dimensional areas, and FIG. 8A to FIG. 8C illustrate examples in which the integration forbidden propositional area R3 of the two-dimensional area is set.

In the first setting example illustrated in FIG. 8A, the proposition integration unit 323 sets a polygon being a minimum area (here, a hexagon) surrounding the forbidden propositional areas R1 and R2 as the integration forbidden propositional area R3. Also, in the second setting example illustrated in FIG. 8B, the proposition integration unit 323 sets a minimum rectangle surrounding the forbidden propositional areas R1 and R2 as the integration forbidden propositional area R3. In the third setting example illustrated in FIG. 8C, the proposition integration unit 323 sets a minimum circle or ellipse surrounding the forbidden propositional areas R1 and R2 as the integration forbidden propositional area R3. In all of these cases, it is possible for the proposition integration unit 323 to suitably set the integration forbidden propositional area R3 which encompasses the forbidden propositional areas R1 and R2.

Also, in the same manner, the proposition integration unit 323 may set a minimum convex polyhedron, sphere, or ellipsoid which encompasses the forbidden propositional area being the subject as the integration forbidden propositional area in a case where the forbidden propositional area is the three-dimensional area.

Note that the integration forbidden propositional area assumed by the integration determination unit 322 to calculate the integration increase rate Pu may be different from the integration forbidden propositional area set by the proposition integration unit 323. For instance, the integration forbidden propositional area based on the second setting example in FIG. 8B may be set in a case where the integration determination unit 322 calculates the integration increase rate Pu for the integration forbidden propositional area based on the first setting example in FIG. 8A to determine whether or not the integration is necessary and the proposition integration unit 323 sets the integration forbidden propositional area.

(5-2-3) Division of the Operable Area

Referring again to FIG. 7, processes will be described, regarding the division of the operable areas of the robot 5, which are executed by the operable area division unit 324 and the divisional area proposition setting unit 325.

The operable area division unit 324 divides the operable area of the robot 5. In this case, the operable area division unit 324 regards, as the operable area, the workspace except for the forbidden propositional area set by the forbidden propositional area setting unit 321 and the integration forbidden propositional area set by the proposition integration unit 323, and divides each of the operable areas based on a predetermined geometric method. For instance, a binary space partitioning, a quadtree, an octree, a Voronoi diagram, or a Delaunay diagram corresponds to the geometric method in this case. In this case, the operable area division unit 324 may generate a two-dimensional divided area by regarding the operable area as the two-dimensional area, and may generate a three-dimensional divided area by regarding the operable area as the three-dimensional area. In another example, the operable area division unit 324 may divide the operable area of the robot 5 by a topological method using a representation by a manifold. In this case, for instance, the operable area division unit 324 divides the operable area of the robot 5 for each local coordinate system.

The divisional area proposition setting unit 325 defines, as a propositional area, each of the operable areas (also referred to as “divided operable areas”) of the robot 5, which are acquired from the division by the operable area division unit 324.

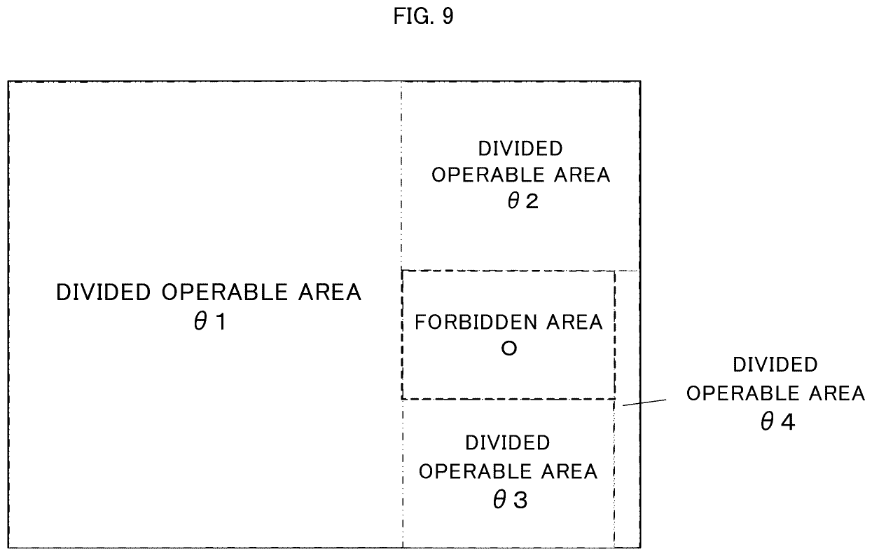

FIG. 9 illustrates a bird's-eye view of the divided operable areas in the example in FIG. 5 or FIG. 6. Here, as an example, the operable area division unit 324 generates four divided operable areas by dividing the workspace other than the forbidden area O based on a line segment or a surface in contact with the forbidden area O. Note that each of the divided operable areas is a rectangular or a rectangular solid. Then, the divisional area proposition setting unit 325 sets propositional areas “θ1” to “θ4” respective to the divided operable areas generated by the operable area division unit 324.

Here, an effect of defining each divided operable area as the proposition will be supplementally described. Each divided operable area which is defined as the propositional area is suitably used in the subsequent process of the operation plan. For instance, in a case where the robot controller 1 needs to move the robot 5 or the robot hand over a plurality of divided operable areas, it becomes possible to simply represent the operation or the robot hand of the robot 5 by the transition of the operable area. In this case, the robot controller 1 can perform the operation plan of the robot 5 for each divided operable area of the target. For instance, the robot controller 1 sets one or more intermediate states (sub-goals) up to a completion state (goal) of the objective task based on the divided operable areas, and sequentially generates the operation sequence of the plurality of robots 5 necessary from the start to the completion of the objective task. Thus, by executing the objective task divided into the plurality of operation plans based on the divided operable areas, it is possible to suitably realize higher speed of the optimization process by the control input generation unit 36, and the robot 5 can be made to suitably perform the target task.

Next, the proposition setting unit 32 outputs information representing the forbidden propositional area which is set by the forbidden propositional area setting unit 321, the integrated forbidden propositional area and the corresponding proposition which are set by the proposition integration unit 323, and the propositional areas corresponding to the divided operable areas which are set by the divisional area proposition setting unit 325. Specifically, the proposition setting unit 32 outputs an abstract state re-setting information ISa in which these pieces of the information are reflected to the abstract state setting information IS.

(5-3) Target Logical Formula Generation Unit

Next, a process executed by the target logical formula generation unit 33 will be specifically described

For instance, in the pick-and-place example illustrated in FIG. 5, suppose that the objective task of “finally all objects are present in the area G” is given. In this case, the target logical formula generation unit 33 generates the following logical formula representing a goal state of the objective task using an operator “⋄” corresponding to “eventually” of a linear logical formula (LTL: Linear Temporal Logic), an operator “□” corresponding to “always”, and a proposition “gᵢ” defined by the abstract state setting unit 31.
∧ᵢ⋄□gᵢ

Note that the target logical formula generation unit 33 may express the logical formula using operators of any temporal logic other than the operators “⋄” and “□” (that is, a logical product “∧”, a logical sum “∨”, a negative “¬”, a logical inclusion “⇒”, a next “◯”, a until “U”, and the like). Moreover, it is not limited to a linear temporal logic, and the logical formula corresponding to the objective task may be expressed using any temporal logic such as an MTL (Metric Temporal Logic) or an STL (Signal Temporal Logic).

Next, the target logical formula generation unit 33 generates the target logical formula Ltag by adding the constraint condition indicated by the constraint condition information I2 to the logical formula representing the objective task.

For instance, in a case where as constraint conditions corresponding to the pick-and-place illustrated in FIG. 5, two constraint conditions are included in the constraint condition information I2; “the robot arms 52 always do not interfere with each other” and “the target object i always does not interfere with the obstacle O”, the target logical formula generation unit 33 converts these constraint conditions into the logical formulae. In detail, the target logical formula generation unit 33 converts the above-described two constraint conditions into the following logical formulae, respectively, using the proposition “oᵢ” defined by the proposition setting unit 32 and the proposition “h” defined by the abstract state setting unit 31.
□¬h
∧ᵢ□¬oᵢ

Therefore, in this case, the target logical formula generation unit 33 adds the logical formulae of these constraint conditions to the logical formula “∧₁⋄□gᵢ” corresponding to the objective task that “finally all objects are present in the area G”, and generates the following target logical formula Ltag.
(∧ᵢ⋄□gᵢ) ∧ (□¬h) ∧ (∧ᵢ□¬oᵢ)

In practice, the constraint conditions corresponding to the pick-and-place are not limited to the two described above constraint conditions, and constraint conditions exist such as “the robot arm 52 does not interfere with the obstacle O,” “the plurality of robot arms 52 do not grab the same target object,” and “the target objects do not contact with each other”. Similarly, these constraint conditions are stored in the constraint condition information I2 and reflected in the target logical formula Ltag.

Next, an example illustrated in FIG. 6 will be described in a case where the robot 5 is the mobile body. In this case, the target logical formula generation unit 33 sets the following logic proposition representing “finally all robots are present in the area G” as a logical formula representing the objective task.
∧ᵢ⋄□gᵢ

In addition, in a case where two constraint conditions, namely, “the robots do not interfere with each other” and “the robot i always does not interfere with the obstacle O”, are included in the constraint condition information I2, the target logical formula generation unit 33 converts these constraint conditions into the logical formulae. In detail, the target logical formula generation unit 33 converts the above-described two constraint conditions into the following logical formulae, respectively, using the proposition “oᵢ” defined by the proposition setting unit 32 and the proposition “h” defined by the abstract state setting unit 31.
□¬h
∧ᵢ□¬oᵢ

Therefore, in this case, the target logical formula generation unit 33 adds the logical formula of these constraint conditions to the logical formula “∧ᵢ⋄□gᵢ” corresponding to the objective task that “finally all the robots exist in the area G” to generate the following target logical formula Ltag.
(∧ᵢ⋄□gᵢ)∧(□¬h)∧(∧ᵢ□¬oᵢ)

Accordingly, even in a case where the robot 5 is the mobile body, the target logical formula generation unit 33 is able to suitably generate the target logical formula Ltag based on a process result of the abstract state setting unit 31.

(5-3) Time Step Logical Formula Generation Unit

The time step logical formula generation unit 34 determines the number of time steps (also referred to as a “target time step number”) for completing the objective task, and determines a combination of propositions which represent the state at every time step such that the target logical formula Ltag is satisfied with the target time step number. Since there are usually a plurality of combinations, the time step logical formula generation unit 34 generates the logical formula in which these combinations are combined by the logical sum as the time step logical formula Lts. The above-described combination corresponds to a candidate for the logical formula representing a sequence of operations to be instructed to the robot 5, and is also referred to as a “candidate φ” hereafter.

Here, a specific example of the process of the time step logical formula generation unit 34 will be described in the description of the pick-and-place illustrated in FIG. 5.

Here, for simplicity of explanations, it is assumed that the objective task of “finally the target object i (i=2) is present in the area G” is set, and the following target logical formula Ltag corresponding to this objective task is supplied from the target logical formula generation unit 33 to the time step logical formula generation unit 34.
(⋄□g₂)∧(□¬h)∧(∧ᵢ□¬oᵢ)

In this instance, the time step logical formula generation unit 34 uses the proposition “g_{i,k}” which is an extension of the proposition “gᵢ” so as to include the concept of the time steps. The proposition “g_{i,k}” is a proposition that the target object i exists in the area G at a time step k.

Here, when the target time step number is set to “3”, the target logical formula Ltag is rewritten as follows.
(⋄□g_{2,3})∧(∧_{k=1,2,3}□¬hₖ)∧(∧_{i,k=1,2,3}□¬o_{i,k})

Moreover, “⋄□g_{2,3}” can be rewritten as illustrated in the following equation (1).

$$\begin{matrix}[ Math . 1 ] & \\ {◇□g}_{2 , 3} = ( ¬ {g}_{2 , 1} ∧ ¬ {g}_{2 , 2} ∧ {g}_{2 , 3} ) ∨ ( ¬ {g}_{2 , 1} ∧ {g}_{2 , 2} ∧ {g}_{2 , 3} ) ∨ ( {g}_{2 , 1} ∧ ¬ {g}_{2 , 2} ∧ {g}_{2 , 3} ) ∨ ( {g}_{2 , 1} ∧ {g}_{2 , 2} ∧ {g}_{2 , 3} ) & ( 1 )\end{matrix}$$

At this time, the target logical formula Ltag described above is represented by the logical sum (φ₁∨φ₂∨φ₃∨φ₄) of the four candidates “φ₁” to “φ₄” illustrated in the following an equation (2) to an equation (5).

[Math 2]

ϕ₁=(¬g_{2,1}∧¬g_{2,2}∧g_{2,3})∧(∧_{k=1,2,3}□¬hₖ)∧(∧_{i,k=1,2,3}□¬o_{i,k}) (2)

ϕ₂=(¬g_{2,1}∧g_{2,2}∧g_{2,3})∧(∧_{k=1,2,3}□¬hₖ)∧(∧_{i,k=1,2,3}□¬o_{i,k}) (3)

ϕ₃=(g_{2,1}∧¬g_{2,2}∧g_{2,3})∧(∧_{k=1,2,3}□¬hₖ)∧(∧_{i,k=1,2,3}□¬o_{i,k}) (4)

ϕ₄=(g_{2,1}∧g_{2,2}∧g_{2,3})∧(∧_{k=1,2,3}□¬hₖ)∧(∧_{i,k=1,2,3}□¬o_{i,k}) (5)

Therefore, the time step logical formula generation unit 34 defines the logical sum of the four candidates φ₁ to φ₄ as the time step logical formula Lts. In this case, the time step logical formula Lts is true when at least one of the four candidates φ₁ to φ₄ is true. Instead of being incorporated into candidates φ₁ to φ₄, the portion “(∧_{k=1,2,3}□¬hₖ)∧(∧_{i,k=1,2,3}□¬o_{i,k})” corresponding to the constraint conditions of the respective candidates φ₁ to φ₄ may be combined with the candidates φ₁ to φ₄ by the logical production in the optimization process performed by the control input generation unit 36.

Next, a case where the robot 5 illustrated in FIG. 6 is the mobile body will be described. Here, for the sake of simplicity of explanations, it is assumed that the objective task of “finally the target object i (i=2) is present in the area G” is set, and the following target logical formula Ltag corresponding to this objective task is supplied from the target logical formula generation unit 33 to the time step logical formula generation unit 34. In this instance, the following target logical formula Ltag is supplied from the target logical formula generation unit 33 to the time step logical formula generation unit 34.
(∧ᵢ⋄□g₂)∧(□¬h)∧(∧ᵢ□¬oᵢ)

In this instance, the time step logical formula generation unit 34 uses the proposition “g_{i,k}” in which the proposition “gᵢ” is extended to include the concept of time steps. Here, the proposition “g_{i,k}” is a proposition that “the robot i exists in the area G at the time step k”. Here, in a case where the target time step number is set to “3”, the target logical formula Ltag is rewritten as follows.
(⋄□g_{2,3})∧(∧_{k=1,2,3}□¬hₖ)∧(∧_{i,k=1,2,3}□¬o_{i,k})

Also, “⋄□g_{2,3}” can be rewritten to the equation (1) similar to the example of the pick-and-place. Similar to example of the pick-and-place, the target logical formula Ltag is represented by the logical sum (φ₁∨φ₂∨φ₃∨φ₄) of the four candidates “φ₁” to “φ₄” represented in the equations (2) to (5). Therefore, the time step logical formula generation unit 34 defines the logical sum of the four candidates “φ₁” to “φ₄” as the time step logical formula Lts. In this case, the time step logical formula Lts is true when at least one of the four candidate “φ₁” to “φ₄” is true.

Next, a method for setting the target time step number will be supplementarily described.

For instance, the time step logical formula generation unit 34 determines the target time step number based on the estimated time of the work specified by the input signal supplied from the instruction device 2. In this case, the time step logical formula generation unit 34 calculates the target time step number from the above-described estimated time based on information of a time span per time step stored in the memory 12 or the storage device 4. In another example, the time step logical formula generation unit 34 stores the information corresponding to the target time step number suitable for each type of the objective task in advance in the memory 12 or the storage device 4, and determines the target time step number according to the type of the objective task to be executed by referring to the information.

Preferably, the time step logical formula generation unit 34 sets the target time step number to a predetermined initial value. Next, the time step logical formula generation unit 34 gradually increases the target time step number until the time step logical formula Lts for the control input generation unit 36 to determine the control input is generated. In this case, the time step logical formula generation unit 34 adds a predetermined number (an integer equal to or greater than 1) to the target time step number in a case where the optimal solution is not derived as a result of the optimization process performed by the control input generation unit 36 according to the set target time step number.

At this time, the time step logical formula generation unit 34 may set the initial value of the target time step number to be a value smaller than the number of time steps corresponding to the working time of the objective task which the user expects. Therefore, it is possible for the time step logical formula generation unit 34 to suitably suppress setting the target time step number to be an unnecessarily large.

(5-5) Abstract Model Generation Unit

The abstract model generation unit 35 generates the abstract model E based on the abstract model information I5 and the abstract state re-setting information Isa.

For instance, the abstract model Σ will be described in a case where the objective task is the pick-and-place. In this instance, a general-purpose abstract model that does not specify the positions and the number of target objects, the positions of the areas where the target objects are placed, the number of the robots 5 (or the number of the robot arms 52), or the like is recorded in the abstract model information I5. Next, the abstract model generation unit 35 generates the abstract model Σ by reflecting the abstract state, the propositional area, and the like which are represented by the abstract state re-setting information ISa for the model of the general-purpose type including the dynamics of the robot 5 which is recorded in the abstract model information I5. Accordingly, the abstract model Σ is the model in which the state of the object in the workspace and the dynamics of the robot 5 are expressed abstractly. In the case of the pick-and-place, the state of the object in the workspace indicates the positions and the numbers of the target objects, the positions of the areas where the target objects are placed, the number of the robots 5, the position and sizes of the obstacle, and the like.

Here, the dynamics in the workspace frequently switches when working on the objective task with the pick-and-place. For instance, in the example of the pick-and-place illustrated in FIG. 5, when the robot arm 52 is grabbing the target object i, the target object i can be moved, but when the robot arm 52 is not grabbing the target object i, the target object i cannot be moved.

With consideration of the above, in the present example embodiment, in the case of the pick-and-place, the operation of grasping the target object i is represented abstractly by a logical variable “δᵢ”. In this case, for instance, the abstract model generation unit 35 can determine the dynamics model of the abstract model Σ to be set for the workspace in the example of the pick-and-place in FIG. 5 by using the following equation (6).

$$\begin{matrix}[ Math . 3 ] & \\ \begin{matrix}{[ \begin{matrix}{x}_{r 1} \\ {x}_{r 2} \\ {x}_{1} \\ ⋮ \\ {x}_{4}\end{matrix} ]}_{k + 1} = {l [ \begin{matrix}{x}_{r 1} \\ {x}_{r 2} \\ {x}_{1} \\ ⋮ \\ {x}_{4}\end{matrix} ]}_{k} + [ \begin{matrix}I & 0 \\ 0 & I \\ {δ}_{1 , 1} I & {δ}_{2 , 1} I \\ ⋮ & ⋮ \\ {δ}_{1 , 4} I & {δ}_{2 , 4} I\end{matrix} ] [ \begin{matrix}{u}_{1} \\ {u}_{2}\end{matrix} ] \\ \begin{matrix}{h}_{{ij}_{min}} & ( 1 - {δ}_{i} ) \leq {h}_{ij} ( x ) \leq {h}_{{ij}_{max}} & {δ}_{i} + ( {δ}_{i} - 1 ) ε\end{matrix}\end{matrix} & ( 6 )\end{matrix}$$

Here, “uⱼ” denotes the control input for controlling the robot hand j (“j=1” indicates the robot hand 53a, and “j=2” indicates the robot hand 53b), “I” denotes an identity matrix, and “0” denotes a zero matrix. Note that although the control input is here assumed as speed as an example, the control input may be acceleration. Also, “δ_{j,i}” denotes a logical variable which indicates “1” when the robot hand j grabs the target object i and indicates “0” otherwise. Also, “xᵣ₁” and “xᵣ₂” denote the position vectors of the robot hands j (j=1, 2), and “x₁” to “x₄” denote the position vectors of the target objects i (i=1 to 4). In addition, “h(x)” denotes a variable which satisfies “h(x)≥0” when the robot hand exists in a vicinity of the target object to the extent that the target object can be grasped, and which satisfies the following relationship with the logical variable δ.

δ=1⇔h(x)≥0

In this equation, when the robot hand exists in the vicinity of the target object to the extent that the target object can be grasped, it is considered that the robot hand grasps the target object, and the logical variable δ is set to 1.

Here, the equation (6) is a difference equation representing the relationship between the state of the object at the time step k and the state of the object at the time step k+1. Then, in the above-described equation (6), since the state of grasping is represented by the logical variable which is the discrete value, and the movement of the object is represented by a continuous value, the equation (6) illustrates the hybrid system.

Moreover, in the equation (6), it is considered that only the dynamics of the robot hand, which is the hand tip of the robot 5 actually grasping the target object, is considered, rather than the detailed dynamics of the entire robot 5. By this consideration, it is possible to suitably reduce a calculation amount of the optimization process by the control input generation unit 36.

Moreover, the abstract model information I5 records information concerning the logical variable corresponding to the operation (the operation of grasping the target object i in the case of the pick-and-place) for which dynamics are switched, and information for deriving the difference equation according to the equation (6) from the recognition result of an object based on the measurement signal S2 or the like. Therefore, it is possible for the abstract model generation unit 35 to determine the abstract model Σ in line with the environment of the target workspace based on the abstract model information I5 and the recognition result of the object even in a case where the positions and the number of the target objects, the areas (the area G in FIG. 5) where the target objects are placed, the number of the robots 5, and the like vary.

Note that in a case where another working body exists, information concerning the abstracted dynamics of another working body may be included in the abstract model information I5. In this case, the dynamics model of the abstract model Σ is a model in which the state of the objects in the workspace, the dynamics of the robot 5, and the dynamics of another working object are abstractly expressed. In addition, the abstract model generation unit 35 may generate a model of the hybrid system with which a mixed logic dynamical (MLD: Mixed Logical Dynamical) system, a Petri net, an automaton, or the like is combined, instead of the model represented in the equation (6).

Next, the dynamics model of the abstract model Σ will be described in a case where the robot 5 illustrated in FIG. 6 is the mobile body. In this instance, the abstract model generation unit 35 determines the dynamics model of the abstract model Σ to be set for the workspace illustrated in FIG. 6 using a state vector x₁ for the robot (i=1) and a state vector x₂ for the robot (i=2) by the following equation (7).

$$\begin{matrix}[ Math . 4 ] & \\ {[ \begin{matrix}{x}_{1} \\ {x}_{2}\end{matrix} ]}_{k + 1} = {[ \begin{matrix}{A}_{1} & O \\ O & {A}_{2}\end{matrix} ] [ \begin{matrix}{x}_{1} \\ {x}_{2}\end{matrix} ]}_{k} + {[ \begin{matrix}{B}_{1} & O \\ O & {B}_{2}\end{matrix} ] [ \begin{matrix}{u}_{1} \\ {u}_{2}\end{matrix} ]}_{k} & ( 7 )\end{matrix}$$

Here, “u₁” represents the input vector for the robot (i=1), and “u₂” represents the input vector for the robot (i=2). Also, “A₁”, “A₂”, “B₁”, and “B₂” are matrixes and are defined based on the abstract model information I5.

In another example, in a case where there are a plurality of operation modes of the robot i, the abstract model generation unit 35 may represent the abstract model E to be set with respect to the workspace depicted in FIG. 6, by the hybrid system in which the dynamics are switched according to the operation mode of the robot i. In this instance, when the operation mode of the robot i is set to “mi”, the abstract model generation unit 35 determines the abstract model Σ to be set with respect to the workspace illustrated in FIG. 6 by the following equation (8).

$$\begin{matrix}[ Math . 5 ] & \\ {[ \begin{matrix}{x}_{1} \\ {x}_{2}\end{matrix} ]}_{k + 1} = {[ \begin{matrix}{A}_{1 {m}_{1}} & O \\ O & {A}_{{2}_{{m}_{2}}}\end{matrix} ] [ \begin{matrix}{x}_{1} \\ {x}_{2}\end{matrix} ]}_{k} + {[ \begin{matrix}{B}_{{1}_{{m}_{1}}} & O \\ O & {B}_{{2}_{{m}_{2}}}\end{matrix} ] [ \begin{matrix}{u}_{1} \\ {u}_{2}\end{matrix} ]}_{k} & ( 8 )\end{matrix}$$

Accordingly, even in a case where the robot 5 is the mobile body, it is possible for the abstract model generation unit 35 to suitably determine the dynamics model of the abstract model Σ. The abstract model generation unit 35 may generate a model of the hybrid system in which the MLD system, the Petri net, an automaton, or the like is combined, instead of the model represented by the equation (7) or the equation (8).

The vector xᵢ and the input uᵢ representing the states of the target object and the robot 5 in the abstract model illustrated in the equations (6) to (8) and the like may be discrete values. Even in a case where the vector xᵢ and the input uᵢ are represented discretely, the abstract model generation unit 35 can set an abstract model machine that suitably abstracts the actual dynamics. In addition, when the objective task in which the robot 5 moves and performs the pick-and-place is set, the abstract model generation unit 35 sets the dynamics model on the assumption of switching of the operation mode as illustrated in the equation 8, for instance.

Moreover, the vector xᵢ and the input uᵢ representing the states of the objects and the robot 5 used in the equations (6) to (8) are defined in a form suitable for the forbidden propositional area and the divided operable areas set by the proposition setting unit 32, particularly when considered in discrete values. Therefore, in this case, the abstract model Σ in which the forbidden propositional area set by the proposition setting unit 32 is considered is generated.

Here, a case of discretizing a space and representing the space as a state (most simply, by a grid representation). In this case, for instance, the larger the forbidden propositional area, the longer the length of one side of the grid (that is, discretized unit space), and the smaller the forbidden propositional area, the shorter the length of one side of the grid.

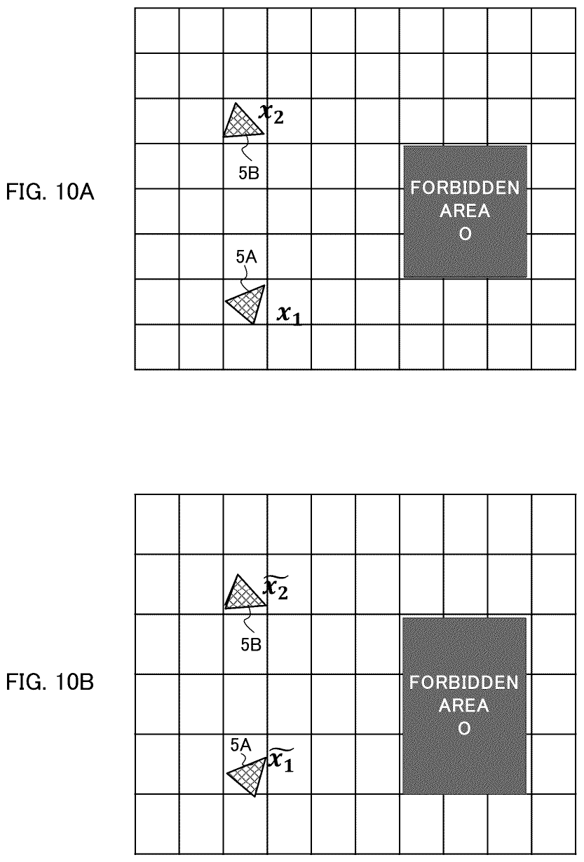

FIG. 10A illustrates a bird's-eye view of the workspace of the robots 5A and 5B in which the forbidden area O, which is the forbidden propositional area in a case where the space is discretized, is specified in the example in FIG. 6. Furthermore, FIG. 10B illustrates a bird's-eye view of the working space of the robots 5A and 5B in a case where a larger forbidden area O is set even in an example in FIG. 10A. In FIG. 10A and FIG. 10B, the area G which is the destination of the robots 5A and 5B is not illustrated for convenience of explanation. In FIG. 10A and FIG. 10B, the lengths of the vertical and horizontal sides of the grid are determined according to the size of the forbidden area O as an example; specifically, in any example, the lengths of the vertical and horizontal sides of the grid are determined to be approximately ⅓ the vertical and horizontal lengths of the forbidden area O, respectively.

Here, since the discretization aspects are different between the case of FIG. 10A and the case of FIG. 10B, representations of the state vectors of the robots 5A and 5B are different in each case. In other words, the state vectors “x₁” and “x₂” of the robots 5A and 5B in FIG. 10A differ from state vectors “ [symbol] ” and “ [symbol] ” in FIG. 10B which represents the state of the robots 5A and 5B in the same state as that in FIG. 10A. As a result, the abstract models Σ generated respectively for the cases in FIG. 10A and FIG. 10B are also different. Accordingly, the abstract model Σ changes according to the forbidden propositional area and the divided operable areas set by the proposition setting unit 32.

Note that the length of one side of the specific grid is actually determined by considering the input uᵢ. For instance, the greater the amount of a movement (operation amount) of the robot in one time step, the greater the length of one side, and the smaller the amount of the movement, the smaller the length of the one side.

(5-6) Control Input Generation Unit

The control input generation unit 36 determines an optimum control input to the robot 5 for each time step, based on the time step logical formula Lts supplied from the time step logical formula generation unit 34 and the abstract model Σ supplied from the abstract model generation unit 35. In this case, the control input generation unit 36 defines the evaluation function for the objective task, and solves the optimization problem for minimizing the evaluation function using the abstract model Σ and the time step logical formula Lts as the constraint conditions. For instance, the evaluation function is predetermined for each type of the objective task, and is stored in the memory 12 or the storage device 4.

For instance, the control input generation unit 36 sets the evaluation function based on the control input “uₖ”. In this case, the control input generation unit 36 minimizes the evaluation function such that the smaller the control input uₖ is (that is, the smaller the energy consumed by the robot 5 is), and the larger the environment evaluation value y is (that is, the higher the accuracy of the information in the whole workspace is), when there is the unset object. In detail, the control input generation unit 36 solves a constrained mixed integer optimization problem shown in the following equation (9) in which the abstract model Σ and the logical formula the time step logical formula Lts (that is, the logical sum of the candidates φᵢ) are the constraint conditions.

$$\begin{matrix}[ Math . 6 ] & \\ {min}_{U} ( {\sum }_{k = 0}^{T} ( {‖ {U}_{k} ‖}^{2} ) ) & ( 9 )\end{matrix}$$

$$s . t . \sum$$

$${∨}_{i} {ϕ}_{i}$$

“T” denotes the number of time steps to be optimized, may be the number of target time steps, and may be a predetermined number smaller than the number of target time steps. In this case, preferably, the control input generation unit 36 may approximate a logical variable to a continuous value (a continuous relaxation problem). Accordingly, the control input generation unit 36 can suitably reduce the amount of computation. Note that in a case where a STL is used instead of the linear logical formula (LTL), the logical formula can be described as a nonlinear optimization problem.

Furthermore, in a case where the target time step number is greater (for instance, greater than a predetermined threshold value), the control input generation unit 36 may set the time step number used for the optimization to a value (for instance, the above-described threshold) smaller than the target time step number. In this case, the control input generation unit 36 sequentially determines the control input uₖ by solving the above-described optimization problem every time a predetermined number of time steps elapses. In this case, the control input generation unit 36 may solve the above-described optimization problem for each predetermined event corresponding to the intermediate state for the achievement state of the objective task, and determine the control input uₖ. In this case, the control input generation unit 36 sets the number of time steps until a next event occurs, to the number of time steps used for optimization. The above-described event is, for instance, an event in which the dynamics in the workspace are switched. For instance, in a case where the pick-and-place is the objective task, an event is defined such as an event in which the robot 5 grasps the target object, an event in which the robot 5 finishes carrying one object to the destination of the plurality of target objects to be carried, or another event. For instance, the event is defined in advance for each type of the objective task, and information specifying the event for each type of the objective task is stored in the storage device 4.

(5-7) Robot Control Unit

The robot control unit 37 generates a sequence of subtasks (a subtask sequence) based on the control input information Icn supplied from the control input generation unit 36 and the subtask information I4 stored in the application information storage unit 41. In this instance, the robot control unit 37 recognizes the subtask that can be accepted by the robot 5 by referring to the subtask information I4, and converts the control input for each time step indicated by the control input information Icn into the subtask.

For instance, in the subtask information I4, two subtasks for moving (reaching) of the robot hand and grasping of the robot hand are defined as subtasks that can be accepted by the robot 5 in a case where the objective task is the pick-and-place. In this case, the function “Move” representing the reaching is, for instance, a function in which the initial state of the robot 5 prior to the execution of the function, the final state of the robot 5 after the execution of the function, and the time necessary to execute the function are respective arguments. In addition, the function “Grasp” representing the grasping is, for instance, a function in which the state of the robot 5 before the execution of the function, the state of the target object to be grasped before the execution of the function, and the logical variable δ are respective arguments. Here, the function “Grasp” represents a grasping operation for the logical variable δ that is “1”, and represents a releasing operation for the logic variable δ that is “0”. In this instance, the robot control unit 37 determines the function “Move” based on a trajectory of the robot hand determined by the control input for each time step indicated by the control input information Icn, and determines the function “Grasp” based on the transition of the logical variable δ for each time step indicated by the control input information Icn.

Accordingly, the robot control unit 37 generates a sequence formed by the function “Move” and the function “Grasp”, and supplies the control signal S1 representing the sequence to the robot 5. For instance, in a case where the objective task is “finally the target object i (i=2) is present in the area G”, the robot control unit 37 generates the sequence of the function “Move”, the function “Grasp”, the function “Move”, and the function “Grasp” for the robot hand closest to the target object (i=2). In this instance, the robot hand closest to the target object (i=2) moves to the position of the target object (i=2) by the first function “Move”, grasps the target object (i=2) by the first function “Grasp”, moves to the area G by the second function “Move”, and places the target object (i=2) in the area G by the second function “Grasp”.

(6) Process Flow

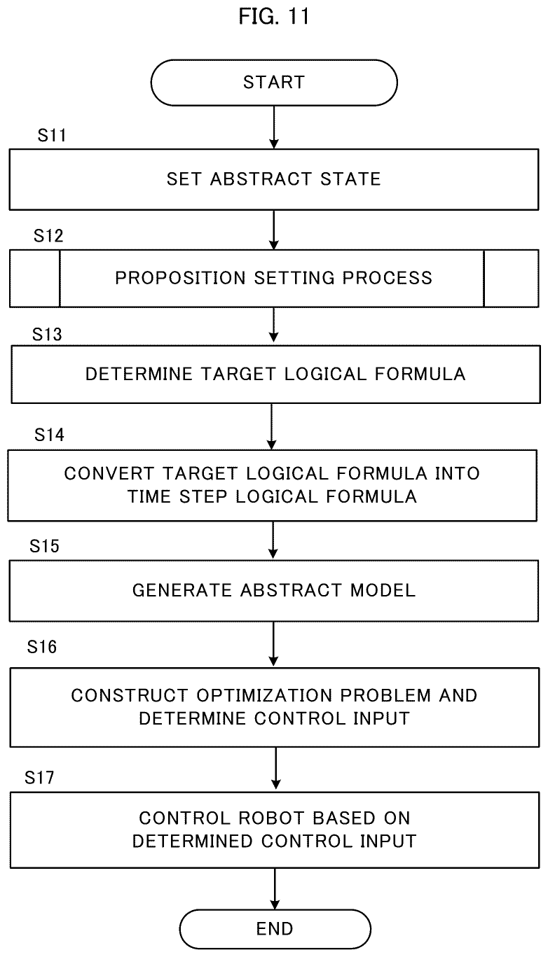

FIG. 11 is an example of a flowchart illustrating an outline of a robot control process executed by the robot controller 1 in the first example embodiment.

First, the abstract state setting unit 31 of the robot controller 1 sets the abstract state of the object existing in the workspace (step S11). Here, the abstract state setting unit 31 executes step S1, for instance, when an external input instructing an execution of a predetermined objective task is received from the instruction device 2 or the like. In step S11, the abstract state setting unit 31 sets a state vector such as the proposition, the position, and the posture concerning the object related to the objective task based on, for instance, the abstract state specification information I1, the object model information I6, and the measurement signal S2.

Next, the proposition setting unit 32 executes the proposition setting process, which is a process of generating an abstract state re-setting information ISa from the abstract state setting information IS by referring to the relative area database I7 (step S12). By the proposition setting process, the proposition setting unit 32 sets the forbidden propositional area, sets the integrated forbidden propositional area, and sets the divided operable areas.

Next, the target logical formula generation unit 33 determines the target logical formula Ltag based on the abstract state re-setting information ISa generated by the proposition setting process of step S12 (step S13). In this case, the target logical formula generation unit 33 adds the constraint condition in executing the objective task to the target logical formula Ltag by referring to the constraint condition information T2.

Next, the time step logical formula generation unit 34 converts the target logical formula Ltag into the time step logical formula Lts representing the state at every time step (step S14). In this instance, the time step logical formula generation unit 34 determines the target time step number, and generates, as the time step logical formula Lts, the logical sum of candidates p each representing the state at every time step such that the target logical formula Ltag is satisfied with the target time step number. In this instance, preferably, the time step logical formula generation unit 34 may determine the feasibility of the respective candidates p by referring to the operation limit information I3, and may exclude the candidates p that are determined to be non-executable from the time step logic Lts.

Next, the abstract model generation unit 35 generates the abstract model Σ (step S15). In this instance, the abstract model generation unit 35 generates the abstract model Σ based on the abstract state re-setting information ISa and the abstract model information I5.

Next, the control input generation unit 36 constructs the optimization problem based on the process results of step S11 to step S15, and determines the control input by solving the constructed optimization problem (step S16). In this case, for instance, the control input generation unit 36 constructs the optimization problem as expressed in the equation (9), and determines the control input such as to minimize the evaluation function which is set based on the control input.

Next, the robot control unit 37 controls each robot 5 based on the control input determined in step S16 (step S17). In this case, for instance, the robot control unit 37 converts the control input determined in step S16 into a sequence of subtasks interpretable for the robot 5 by referring to the subtask information I4, and supplies the control signal S1 representing the sequence to the robot 5. By this control, it is possible for the robot controller 1 to make each robot 5 suitably perform the operation necessary to execute the objective task.

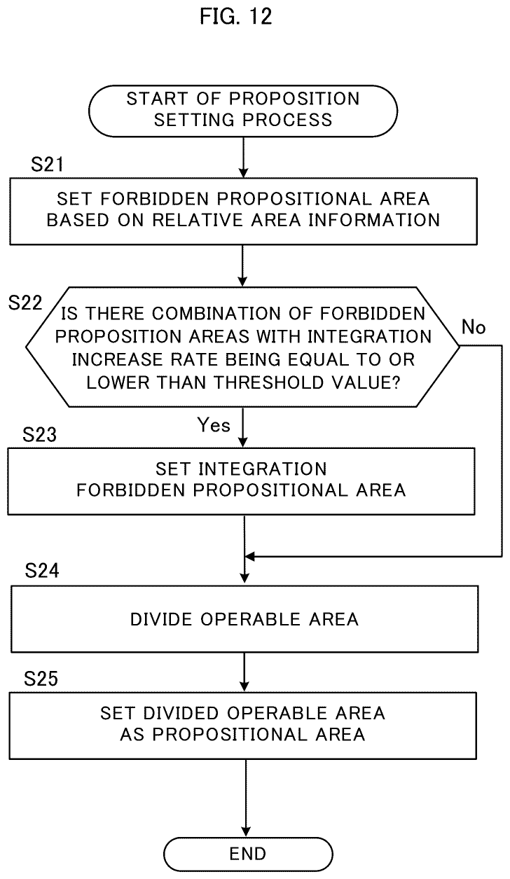

FIG. 12 is an example of a flowchart illustrating a sequence of a proposition setting process that is executed by the proposition setting unit 32 in step S12 in FIG. 11.

First, the proposition setting unit 32 sets the forbidden propositional area based on the relative area information included in the relative area database I7 (step S21). In this case, the forbidden propositional area setting unit 321 of the proposition setting unit 32 extracts the relative area information corresponding to predetermined objects such as obstacles corresponding to the propositions for which the forbidden propositional area is to be set from the relative area database I7. Next, the forbidden propositional area setting unit 321 sets an area in which the relative area indicated by the extracted relative area information is defined in the workspace based on the position and the posture of the object, as the forbidden propositional area.

Next, the integration determination unit 322 determines whether or not there is the combination of the forbidden propositional areas in which the integration increase rate Pu is equal to or less than the threshold value Puth (step S22). Next, when the integration determination unit 322 determines that there is the combination of the forbidden propositional areas in which the integration increase rate Pu is equal to or less than the threshold value Puth (step S22; Yes), the proposition integration unit 323 sets an integrated forbidden propositional area in which the combination of the forbidden propositional areas in which the integration increase rate Pu is equal to or less than the threshold value Puth (step S23). Moreover, the proposition integration unit 323 redefines related propositions. On the other hand, when the integration determination unit 322 determines that there is no combination of the forbidden propositional areas in which the integration increase rate Pu is equal to or less than the threshold value Puth (step S22; No), the propositional setting unit 32 advances the process to step S24.

Next, the operable area division unit 324 divides the operable area of each robot 5 (step S24). In this case, for instance, the operable area division unit 324 regards, as the operable area, the workspace except for the forbidden propositional area set by the forbidden propositional area setting unit 321 and the integrated forbidden propositional area set by the proposition integration unit 323, and generates the divided operable areas in which the operable area is divided. Subsequently, the divisional area proposition setting unit 325 sets each of the divided operable areas generated in step S24 as the propositional area (step S25).

(7) Modifications

Next, modifications of the example embodiment described above will be described. The following modifications may be applied to the above-described example embodiment in any combination.

(First Modification)

The proposition setting unit 32 may perform only one of the process related to the integration of the forbidden propositional area by the integration determination unit 322 and the proposition integration unit 323, and the process related to the setting of the divided operable areas by the operable area division unit 324 and the divisional area proposition setting unit 325, instead of the functional block configuration depicted in FIG. 7. Note that in a case in which the process related to the integration of the forbidden propositional areas by the integration determination unit 322 and the proposition integration unit 323 is not executed, the operable area division unit 324 regards the workspace other than the forbidden propositional area set by the forbidden propositional area setting unit 321, as the operable area of the robot 5, and generates the divided operable areas.

Even in this modification, in the configuration of the proposition setting unit 32 that executes the process related to the integration of the forbidden propositional areas, it is possible for the robot controller 1 to suitably represent the abstract state to enable an efficient operation plan by setting the integration forbidden propositional areas corresponding to the plurality of obstacles or the like. On the other hand, in the configuration of the proposition setting unit 32 which executes the process related to the setting of the divided operable areas, it becomes possible for the robot controller 1 to set the divided operable areas and to suitably utilize the divided operable areas in a subsequent operation plan.

Furthermore, in yet another example, the proposition setting unit 32 may have only a function corresponding to the forbidden propositional area setting unit 321. Even in this case, it is possible for the robot controller 1 to suitably formulate the operation plan in consideration of the size of the object such as the obstacle.

(Second Modification)

The forbidden propositional area setting unit 321 may set each propositional area of objects other than the objects (obstacles) that regulate the operable areas of each robot 5. For instance, the forbidden propositional area setting unit 321 may set the propositional area by extracting and referring to corresponding relative area information from the relative area database I7 for a goal point corresponding to the area G, the target object, or the robot hand in the examples in FIG. 5 and FIG. 6. In this case, the proposition integration unit 323 may integrate the same type of the propositional area other than the forbidden propositional area.

Also, the proposition integration unit 323 may integrate propositional area in different ways depending on the corresponding propositions. For instance, in a case where a goal point is defined as an overlapping portion of a plurality of areas in a proposition regarding an object or a goal point of each robot 5, the proposition integration unit 323 determines the overlapping portion of the propositional areas which are set for the plurality of areas, as the propositional area representing the goal point.

(Third Modification)

The functional block configuration of the processor 11 depicted in FIG. 4 is an example, and various changes may be made.

For instance, the application information includes design information such as the control input corresponding to the objective task or a flowchart for designing the subtask sequence in advance, and the robot controller 1 may generate the control input or the subtask sequence by referring to the design information. As for the specific example of executing the task based on the task sequence designed in advance, for instance, Japanese Laid-open Patent Publication No. discloses.

### Second Example Embodiment

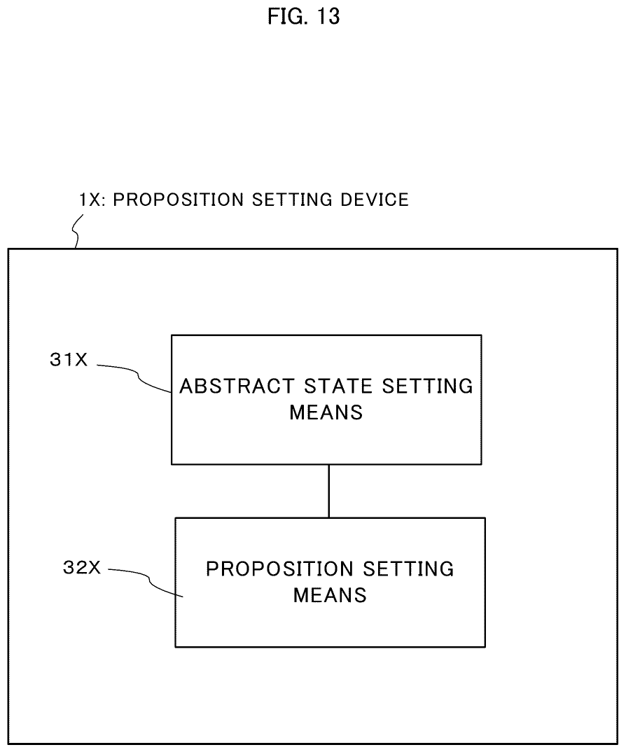

FIG. 13 illustrates a schematic configuration diagram of the proposition setting device 1X in the second example embodiment. The proposition setting device 1X mainly includes an abstract state setting means 31X and a proposition setting means 32X. The proposition setting device 1X may be formed by a plurality of devices. For instance, the proposition setting device 1X can be the robot controller 1 in the first example embodiment.

The abstract state setting means 31X sets an abstract state, which is an abstract state of each object in the workspace, based on measurements in the workspace in which each robot performs the task. For instance, the abstract state setting means 31X can be the abstract state setting unit 31 in the first example embodiment.

The proposition setting means 32X sets the propositional area representing the proposition concerning each object by the area based on the abstract states and the relative area information which is information concerning the relative area of each object. The proposition setting means 32X can be, for instance, the proposition setting unit 32 in the first example embodiment. The proposition setting device 1X may perform the process for generating the operation sequence of each robot based on the process results of the abstract state setting means 31X and the proposition setting means 32X, and may supply the process results of the abstract state setting means 31X and the proposition setting means 32X to other devices that perform the process for generating the operation sequence of the robot.

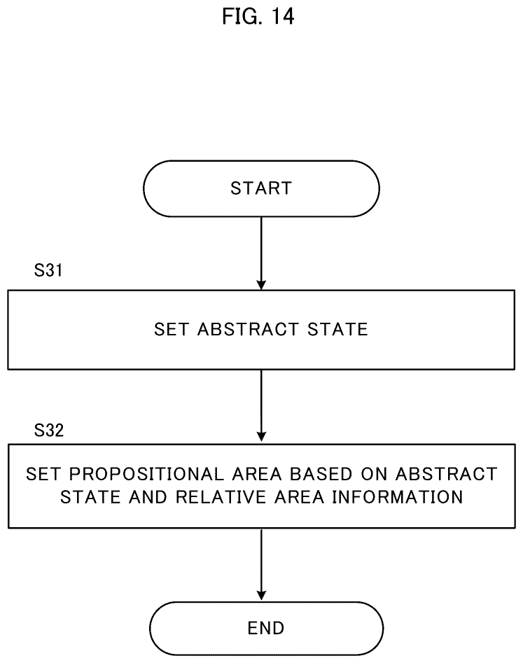

FIG. 14 is an example of a flowchart executed by the proposition setting device 1X in the second example embodiment. First, the abstract state setting means 31X sets the abstract state, which is an abstract state of each object in the workspace, based on the measurement result in the workspace in which each robot performs the work (step S31). The proposition setting means 32X sets the propositional area representing the proposition concerning each object by the area based on the abstract state and the relative area information which is the information concerning the relative area of each object (step S32).

According to the second example embodiment, it is possible for the proposition setting device 1X to suitably set propositional areas to be used in the operation plan of each robot by using the temporal logic.

In the example embodiments described above, the program is stored by any type of a non-transitory computer-readable medium (non-transitory computer readable medium) and can be supplied to a processor or the like that is a computer. The non-transitory computer-readable medium include any type of a tangible storage medium. Examples of the non-transitory computer readable medium include a magnetic storage medium (that is, a flexible disk, a magnetic tape, a hard disk drive), a magnetic-optical storage medium (that is, a magnetic optical disk), a CD-ROM (Read Only Memory), a CD-R, a CD-R/W, a solid-state memory (that is, a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

In addition, some or all of the above example embodiments may also be described as in the following supplementary notes, but are not limited to the following.

(Supplementary Note 1)

A proposition setting device comprising:
an abstract state setting means configured to set an abstract state which is a state abstracting each object in a workspace based on a measurement result in the workspace where each robot works; and
a proposition setting means configured to set a propositional area which represents a proposition concerning each object by an area, based on the abstract state and relative area information which is information concerning a relative area of each object.

(Supplementary Note 2)

The proposition setting device according to supplementary note 1, wherein the proposition setting means includes
a propositional area setting means configured to set the propositional area based on the abstract state and the relative area information;
an integration determination means configured to determine whether or not a plurality of the propositional areas need to be integrated; and
a proposition integration means configured to set the propositional area being integrated, based on the plurality of the propositional areas determined to be integrated.

(Supplementary Note 3)

The proposition setting device according to supplementary note 2, wherein the proposition setting means sets a forbidden propositional area which is the propositional area in a case where each object is an obstacle, based on the abstract state and the relative area information.

(Supplementary Note 4)

The proposition setting device according to supplementary note 3, wherein the integration determination means determines whether or not a plurality of the forbidden propositional areas need to be integrated, based on an increase rate of an area or a volume of the propositional area in a case of integrating the plurality of the forbidden propositional areas.

(Supplementary Note 5)

The proposition setting device according to any one of supplementary notes 1 to 4, wherein the provision setting means includes
an operable area division means configured to divide each operable area of the robot which is specified based on each propositional area; and
a divisional area proposition setting means configured to set the propositional area corresponding to each divided operable area.

(Supplementary Note 6)

The proposition setting device according to any one of supplementary notes 1 to 5, wherein the proposition setting means sets, as the propositional area, an area in which a relative area represented by the relative area information is defined in the work space based on a position and a posture of each object set as the abstract state.

(Supplementary Note 7)

The proposition setting device according to any one of supplementary notes 1 to 6, wherein the proposition setting means extracts the relative area information corresponding to each object specified based on the measurement result, from a database in which the relative area information representing a relative area corresponding to a type of each object is associated with the type of each object, and sets the propositional area based on the relative area information being extracted.

(Supplementary Note 8)

The proposition setting device according to any one of supplementary notes 1 to 7, further comprising an operation sequence generation means configured to generate an operation sequence of the robot based on the abstract state and the propositional area.

(Supplementary Note 9)

The proposition setting device according to supplementary note 8, wherein the operation sequenced generation means includes
a logical formula conversion means configured to convert a task to be executed by the robot into a logical formula based on a temporal logic;
a time step logical formula generation means configured to generate a time step logical formula which is a logical formula representing a state for each time step to execute the task, from the logical formula;
an abstract model generation means configured to generate an abstract model abstracting dynamic in the workspace, based on the abstract area and the propositional area; and
a control input generation means configured to generate a time series of control inputs for the robot by an optimization using the abstract model and the time step logical formula as constraint conditions.

(Supplementary Note 10)

A proposition setting method performed by a computer, comprising:
setting an abstract state which is a state abstracting each object in a workspace based on a measurement result in the workspace where each robot works; and
setting a propositional area which represents a proposition concerning each object by an area, based on the abstract state and relative area information which is information concerning a relative area of each object.

(Supplementary Note 11)

A recording medium storing a program, the program causing a computer to perform a process comprising:
setting an abstract state which is a state abstracting each object in a workspace based on a measurement result in the workspace where each robot works; and
setting a propositional area which represents a proposition concerning each object by an area, based on the abstract state and relative area information which is information concerning a relative area of each object.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF SYMBOLS

1 Robot controller
1X Proposition setting device
2 Instruction device
4 Storage device
Robot
7 Measurement device
41 Application information storage unit
100 Robot control system

What is claimed is:

1. A proposition setting device comprising:
a memory storing instructions; and
one or more processors configured to execute the instructions to:
set an abstract state which is a state abstracting each object in a workspace based on a measurement result in the workspace where each robot works; and
set a propositional area which represents a proposition concerning each object by an area, based on the abstract state and relative area information which is information concerning a relative area of each object.

2. The proposition setting device according to claim 1, wherein the processor is further configured to
set the propositional area based on the abstract state and the relative area information;
determine whether or not a plurality of the propositional areas need to be integrated; and
set the propositional area being integrated, based on the plurality of the propositional areas determined to be integrated.

3. The proposition setting device according to claim 2, wherein the processor sets a forbidden propositional area which is the propositional area in a case where each object is an obstacle, based on the abstract state and the relative area information.

4. The proposition setting device according to claim 3, wherein the processor determines whether or not a plurality of the forbidden propositional areas need to be integrated, based on an increase rate of an area or a volume of the propositional area in a case of integrating the plurality of the forbidden propositional areas.

5. The proposition setting device according to claim 1, wherein the processor is further configured to
divide each operable area of the robot which is specified based on each propositional area; and
set the propositional area corresponding to each divided operable area.

6. The proposition setting device according to claim 1, wherein the processor sets, as the propositional area, an area in which a relative area represented by the relative area information is defined in the work space based on a position and a posture of each object set as the abstract state.

7. The proposition setting device according to claim 1, wherein the processor extracts the relative area information corresponding to each object specified based on the measurement result, from a database in which the relative area information representing a relative area corresponding to a type of each object is associated with the type of each object, and sets the propositional area based on the relative area information being extracted.

8. The proposition setting device according to claim 1, wherein the processor is further configured to generate an operation sequence of the robot based on the abstract state and the propositional area.

9. The proposition setting device according to claim 8, wherein the processor is further configured to
convert a task to be executed by the robot into a logical formula based on a temporal logic;
generate a time step logical formula which is a logical formula representing a state for each time step to execute the task, from the logical formula;
generate an abstract model abstracting dynamic in the workspace, based on the abstract area and the propositional area; and
generate a time series of control inputs for the robot by an optimization using the abstract model and the time step logical formula as constraint conditions.

10. A proposition setting method performed by a computer, comprising:
setting an abstract state which is a state abstracting each object in a workspace based on a measurement result in the workspace where each robot works; and
setting a propositional area which represents a proposition concerning each object by an area, based on the abstract state and relative area information which is information concerning a relative area of each object.

11. A non-transitory computer-readable recording medium storing a program, the program causing a computer to perform a process comprising:
setting an abstract state which is a state abstracting each object in a workspace based on a measurement result in the workspace where each robot works; and
setting a propositional area which represents a proposition concerning each object by an area, based on the abstract state and relative area information which is information concerning a relative area of each object.
